(19) United States
(12) Patent Application Publication
(10) Pub. No.: US 2009/0276351 A1
(43) Pub. Date: Nov. 5, 2009

(54) SCALEABLE SYSTEM AND METHOD FOR DISTRIBUTED PREDICTION MARKETS

(75) Inventor: Peyman Faratin, New York, NY (US)

Correspondence Address: Stolowitz Ford Cowger LLP, 621 SW Morrison St, Suite 600, Portland, OR, 97205, US

(73) Assignee: Strands, Inc., Corvallis, OR (US)

(21) Appl. No.: 12/433,590

(22) Filed: Apr. 30, 2009

Related U.S. Application Data
(60) Provisional application No. 61/049,401, filed on Apr. 30, 2008.

(51) Int. Cl. G06Q 40/00

(52) U.S. Cl. 705/37; 705/35

(57) ABSTRACT

Systems, methods, and software are disclosed to implement distributed prediction markets over the internet. A central platform executes web application software to host prediction markets (FIG. 1A), each of which can be initiated via a widget on a remote web site such as a blogger site (FIG. 1B). A widget communicates with the central server to provide user interface (FIG. 3) to find and select markets and get updates (FIG. 5), and enables a user to register (FIG. 4), bit on markets (propositions), and create their own propositions to become prediction market instances. The central platform provides scalable market provisioning (602, 612), market execution (620, 624), market instance relationships (610), and market closing functions, such as computing rankings (660) and payoffs (650).

### RELATED APPLICATIONS

This application claims priority to U.S. Provisional Application No. 61/049,401 filed Apr. 30, 2008 and incorporated herein by this reference in its entirety.

### COPYRIGHT NOTICE

©2008-2009 Strands, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to methods and apparatus and computer software for the implementation of distributed prediction markets on the Internet.

### BACKGROUND OF THE INVENTION

Prediction markets (PM) are markets where traders buy and sell “securities”. Think of a security as associated with a proposition having a true/false binary outcome or result. Securities have payoffs and time limits. So in general a PM has one random variable (the proposition) that can be true or false. Participants buy and sell contracts/securities that guarantee a payback if the outcome is what they predict. These contracts are “traded” in the market until the outcome becomes a reality. Players then get payoffs according to their outstanding shares of contracts at the conclusion.

For example, one security could be described as follows: “This security, with unique ID SEC:3491, will pay $1 if and only if AT&T releases 3G networks by 2009”. Propositions in these markets have a “sell by” or maturity date (2009 in our example), becoming invalid after that. Imagine the current price of this security SEC:3491 is $0.20. If a trader strongly believes that AT&T will release 3G before 2009, then s/he has a strong economic incentive to buy this security. Prices, set through trading behavior of market participants, then provide information about the market's belief about the likelihood of the event.

Now we have a proposition (with a true/false value at time of maturation), but also a continuous measure of the likelihood of the proposition. This likelihood metric of the expected outcome, reflected in a unit contract price, can vary over time, from the start of trading in a particular security up to the date/time of maturity. In general, after that time, the outcome will be known. Preferably, prediction markets should be addressed to propositions where the outcome or result of each proposition is objectively verifiable. Preferably, it may be ascertainable soon after the maturity date, but some delay is acceptable as well. Any proposition is permissible, ranging from “will Alice date Bob” (a potential Facebook security), to who will win the next presidential election. The only requirement is that the event which the proposition refers to is publicly and objectively verifiable ex-post. More on who makes that determination later.

There are existing web-based PMs. However, although successful in some domains (e.g. Hollywood exchange, Iowa election markets), the web-based markets have suffered from being “thin,” meaning that they have few active traders. Consequently, the value of information derivable from these sites is quite limited. What is needed is a centralized, scalable platform to implement prediction markets that are distributed over the Internet and more specifically over the blogosphere to increase participation and improve the quantity and quality of information that may be assembled from such systems.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

We disclose a scaling strategy through distributing the PM (a Distributed PM, or “DPM”). The hypothesis is that PMs are thin because of high transaction costs of making and participating in markets. Transaction costs include i) search costs, ii) evaluation costs and iii) interaction costs. We want to lower these transaction costs of participation and increase liquidity of market participants. We use the term “market maker” herein to refer to a user who defines or initiates a new PM. One goal is to give bloggers that ability. So that a blogger can easily create a new PM to run through its site. But the blogger does not participate in managing that market, or maintaining a price, or providing liquidity. In this regard we depart from the conventional securities industry meaning of a market-maker. Ours is more like a market-starter or definer.

In some embodiments, the market-maker functionality does not depend on an individual editor or “specialist” (in the securities industry sense). Rather, in some embodiments, we implement the market maker functionality in software to increase both liquidity and scalability.

Any user with Internet access and a web browser or similar application may participate in our distributed prediction markets. In one embodiment, we utilize blogs as an advantageous domain for achieving the scaling goal because the “blogosphere” has many (incentive and information) characteristics that make them a suitable application area for prediction markets. Enabling anyone with an opinion to create a PM on their blog, together with low cost ways of finding, and interconnecting with those PMs by potential participants is expected to create a “thicker” PM market. The invention is not limited, however, to distribution over blogging sites.

In an embodiment, widgets are provided for users to observe and interact with prediction markets. A software widget is a generic type of software application comprising portable code intended for one or more different software platforms. The term often implies that either the application, user interface, or both, are light, meaning relatively simple and easy to use, as exemplified by a desk accessory or applet, as opposed to a more complete software package such as a spreadsheet or word processor.

In various embodiments, aspects of the invention will distribute prediction markets. Rather than requiring users to search out and find stand-alone individual PMs, the content is widely distributed so that many more users can observe and easily participate in PMs of interest to them. For example, the disclosed system enables bloggers or other web sites to easily design and execute PMs on their own sites, with visibility far beyond that specific site. Distribution strategies include widgets, publish-subscribe protocols and notifications to users or potential users.

In another aspect of the invention, PM decision making is widely decentralized (albeit through the use of a central platform in a preferred embodiment). Decisions as to what markets to create, verification of proposition outcomes, and evaluation are distributed well beyond a few specific proprietary markets. The present system enables any user to become a “market maker.” Moreover, the present system helps to incentivize participation, which in turn improves the quantity and thus the quality of future prediction data.

Additional aspects and advantages of this invention will be apparent from the following detailed description of preferred embodiments, which proceeds with reference to the accompanying drawings.

### BRIEF DESCRIPTION OF THE DRAWINGS

FIG. 1A is a simplified diagram illustrating a distributed prediction market system consistent with the present invention.

FIG. 1B is a simplified architecture diagram showing the role of a blogging platform in a distributed prediction markets system.

FIG. 2 illustrates software layers of a web application for implementing aspects of the present invention.

FIG. 3 is a simplified application logic flow diagram for a Landing Page.

FIG. 4 is a simplified application logic flow diagram for market maker registration.

FIG. 5 is a simplified application logic flow diagram for bidder registration.

FIG. 6 is a simplified application logic flow diagram for market provisioning, market execution, market closing and graphing related markets.

FIG. 7 is a logic flow diagram showing more detail of market provisioning functionality of FIG. 6.

FIG. 8 is a simplified application logic flow diagram for generating market code for a landing page or widget probability market.

FIG. 9 is simplified application logic flow diagram for running a prediction market.

FIG. 10 shows additional logic flow for running prediction markets and processing bidder interactions.

FIG. 11 shows an example of a market (or proposition) relationship graph.

FIG. 12 illustrates application logic to present options to a bidder when a proposed bid is out of budget.

FIG. 13 illustrates sample data structures for use in some embodiments.

FIG. 14 represents the execution logic and messaging between various components of the system in an embodiment.

FIG. 15 illustrates execution logic and messaging showing more detail of the market scoring rule implementation.

### DETAILED DESCRIPTION OF THE PREFERRED EMBODIMENTS

We believe the thinness problem is potentially an information problem, arising because there are few market-makers and often whose existence is only known to few individuals. For instance, I know about the BuzzGame (Yahoo's PM) because I know David Pennock (creator of the game) and Rahul (his colleague) and I follow that area of research. Others who maybe less informed about the securities traded on the BuzzGame are probably not aware of this site. The problem we would like to address is how to create “thick”/scalable prediction markets.

Note a subtle but important difference between a PM and an algorithm as two distinct strategies for indexing and searching. An algorithm is endogenous, meaning the algorithm computes inferences based on the underlying structure of the data. Data mining is a process to partition and induce a structure on a (labeled) data set. A PM on the other is an exogenous mechanism, where it is the network that computes the information. A PM is simply a set of rules of behavior (bids and asks and allocations). How agents behave within these rules (or what is commonly referred to as “mechanism” or “institution” in economic literature) defines the required information. It is interactions, not computation, that produces information.

### Blogosphere Context

Information flow in blogs is dynamic, following “chatter” and “burst” modes (see appendix 10.1 for a Wikipedia description of blogs). Information in blogs are often used as sources of information, even before the event is picked up in the mainstream media. Tools exist (such as linktrack, Permalink, blogroll etc, that help bloggers coordinate and blogging search engines (such as Technorati) to index. These technologies have helped to show that blogosphere has clear structure, because bloggers (preferentially) interconnect with other bloggers (using “blogroll” technology—see wiki's entry on blogroll) based on location, age and topic (see paper by kumar ACM).

Bloggers also often have strong opinions and expertise on subject matters, and given interconnections with other related blogs, may have strong incentives to participate in prediction markets. Note, another subtle point. The type of inferences information from current tracking technologies supports are second-order and cannot capture the diverse set of time frequency complexities of information in blogosphere. Furthermore, blog indexers are architected the same as their web counterparts, counting (and weighting) structural information (links), not the content of the information. The rules of the PM provide a compact representation of content; the security and the associated prices induce a natural index on that content. The index is generated exogenously, by the market.

One aspect of the present invention is a platform or system to assemble the dynamic “future information” that is user-generated throughout the blogosphere and other regions of the web. We disclose a platform that provides the following services to different market participants. While such a platform may be centralized in a hardware sense, it operates to coordinate distributed prediction markets. In a preferred embodiment:

Blog owner: The platform preferably gives individual blog owners the ability to become “market makers,” having the freedom to specify, provision and execute a PM on their blog, and on a topic of their choosing (most likely the content of their blog).

Blog reader: Blogs are often already interconnected (“BlogHood”) through various mechanisms (such as Blogroll and/or several online communities, such as BlogCatalog and MyBlogLog), that connect people to blogs and bloggers to other bloggers. Our platform preferably also provides additional interconnection mechanisms for others in the blogosphere (or general Internet) to find and participate in any number of ongoing PMs of interest to them.

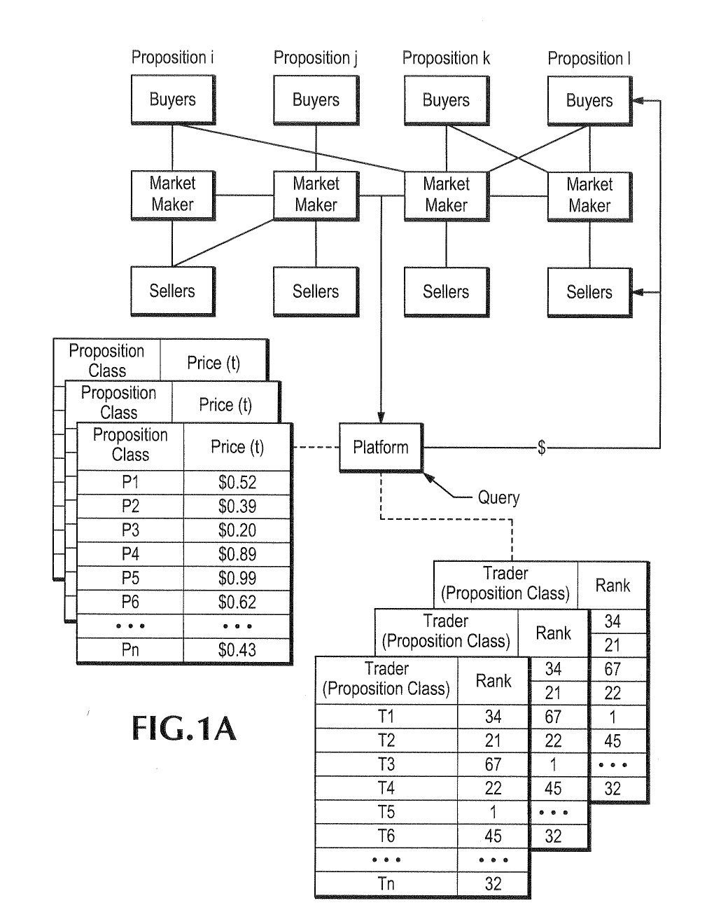

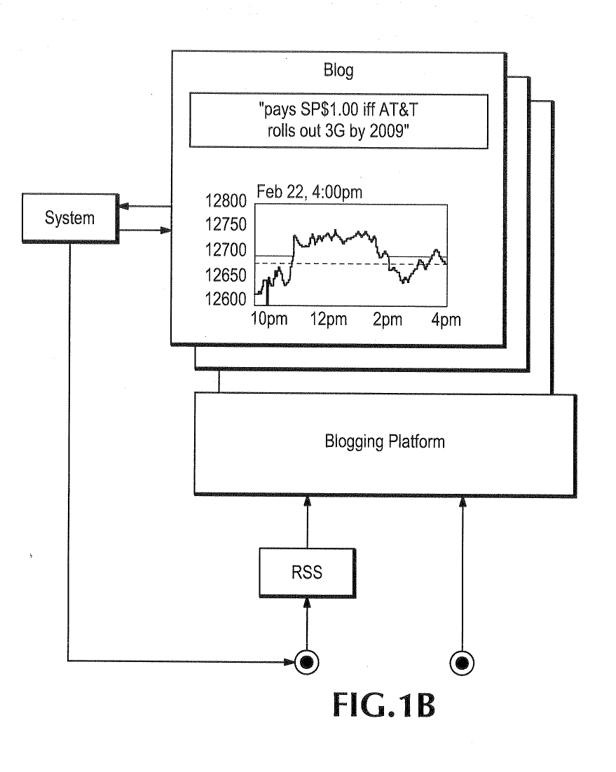

Third party: The activity and outcomes of the distributed PMs can then be queried by other interested third parties (such as marketers, sales, VCs, etc). At least three types of information can be provided by the platform:
Raw events or event class or a distribution of security objects that are being created by the market makers (ex-ante (before) markets opening).
Time-series evolution of proposition probabilities. Because prices in such distributed PMs serve as a compact and clear representation (and sufficient statistics) of the opinion of the traders, event/security price time-series may be relevant to parties who are interested in the evolution of the opinion. (FIG. 1A illustrates one example of a price-time chart.)
Rankings. Ranked order of participants accuracy ratings. The platform essentially provides tools for people to identify themselves as good predictors (similar to second degree pricing mechanisms, such as coupons). They do so by playing a prediction game (ex-post (after) markets closing).

Glossary. As used herein, and in the appended claims, except where otherwise specified, the following terms are defined as follows:

Proposition—a statement with a binary outcome, i.e. true or false.

Market-Maker—entity that creates/specifies a proposition.

Security (or contract) is a contractual obligation associated with an underlying proposition. There are two species of securities for each proposition: a true outcome security, and a false outcome security.

Market—all of the traders participating in buying and selling the (two) securities associated with a given proposition. Traders are also called participants, bidders or players.

Prediction Market or PM—see Market.

Cost Function c=b*log(ê(q1/b)+ê(q2/b)) where b is a liquidity factor; q1 is the number of currently outstanding shares of the true outcome security; q2 is the number of currently outstanding shares of the false outcome security.

FIG. 1A is a simplified diagram illustrating a distributed prediction market system in one embodiment. Propositions i,j,k,l each have a corresponding market maker. In a preferred embodiment, the market maker may be a blogger website. Traders (buyers and sellers) of the associated securities communicate via the DPM platform. Embodiments of the present invention provide the blog owner the tools that lowers his/her costs of becoming a market maker. Traders, from other blogs or the general Internet, can then participate on one or more PMs, utilizing the limited (artificial) currency that has been allocated to them by the platform. Currency allocations are further discussed below.

The trading behavior of the traders would then provide the instantaneous belief of the traders on the proposition. The platform shown at the center of the drawing acts as the coordinator, providing initial and ongoing budget allocation and accounting needs of the traders, as well as the front-end (setup and advertising of markets) and backend infrastructures (clearing price computation, budget constraints, etc) as further explained below.

### Information Architecture

The platform in a preferred embodiment holds state on a live running feed of price statistics of each proposition and the associated participants. For infrastructure scalability or search service rationales, this raw DB of proposition-price tuples can be further structured using information about the structure of propositions, where related propositions (markets) are grouped together in the DB (clustering). We envisage at least three potential types of structures to information:

Membership information: which propositions belong to the same category (for example through a clustering algorithm).

Relational information: Relationship between different propositions. For example, a AT&T market is related to a iPhone market. The strategy to provision for such a structural information that encodes the relationships between markets (and ultimately the underlying propositions themselves) could be model-based (endogenous) or alternatively exogenous, provided, for example, by either the market-maker or the participants. For instance, in an embodiment the platform can provide a market-maker with a list l^{t} of all current and previous markets at time t. Market-makers can then select other markets that are “related” to the market they are in the process of setting up. l^{t} may be unstructured (or manually structured) at first, but evolve a structure over time as market-makers self-organize the list in to a graph.

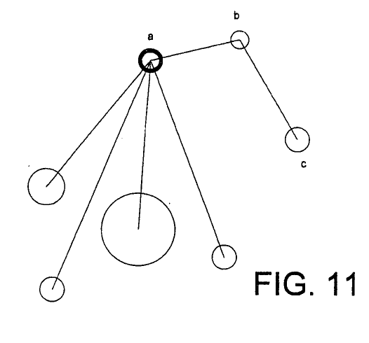

An example of a relationship graph is shown in FIG. 11. In FIG. 11, a relationship graph is shown which can be used to graphically illustrate relationships among prediction market instances. As discussed elsewhere herein, PMs can be related, for example by explicit tagging by users, or by more elaborate analysis of the proposition, e.g. using key words or natural language processing. Categories of markets thus can be determined. Further, other measures can be applied over a selected category of markets. Other metrics may include “hot” markets, based on amount of activity (bidding an or observing); mean square of variations (“controversial” markets); and markets with biggest potential return on investment. In an embodiment, strength of relationship may be indicated by placement of the market tokens (a, b, c). Preferably, the strengths are indicated through a weight displayed adjacent the corresponding link. The relationships or edges of the graph generally are undirected. Size of a market may be indicated by size of the token, for example the number of bids received.

Complex sentences: Propositions may be conjuncted to create complex sentences (“will AT&T release 3G by 2009 and will iPhone open its SDK?”).

This information architecture is provided by way of illustration and not limitation. Still, benefits of this information structuring may include the following:

(a) Computational and scalability: relational information enables partitioning strategies and distributed implementation of the platform, according to proposition class.

(b) Referral and thickening service: the relational information can be used to provide recommendation service to market participants on the blog, about other markets on other blogs that are related to this market (compare to Blogroll). This referral mechanism, if correctly accounted for, can lay the foundation for a revenue model.

(c) Additional context information (embedded and derived from the blogging environment, such as geography or demographics), in addition to this proposition-price information, maybe used for scalability as well as mining and supporting additional inferences and query answering.

In one embodiment, the architecture of the DPM mechanism to allocate propositions and quantify their probabilistic information may be described as middleware, because the mechanism derives its data from the underlying blogging platform and in turn may provide data services to other web applications, such as search. However, the present application is not limited to use on blogging platforms. For example, in one embodiment, a PM widget can be placed on any web site, and any user with access may participate as a trader.

Referring now to FIG. 1B, it shows a set of PMs, one for each potential proposition on a blog site, set up by a blogger who acts as a market-maker. In this drawing, for example, there is a proposition described as, “pays SP$1.00 iff (if and only if) AT&T rolls out 3G by 2009.” The payout is expressed in “SP dollars”—an artificial currency further explained below. The drawing also shows, for the AT&T proposition, a chart of price (or likelihood) over time.

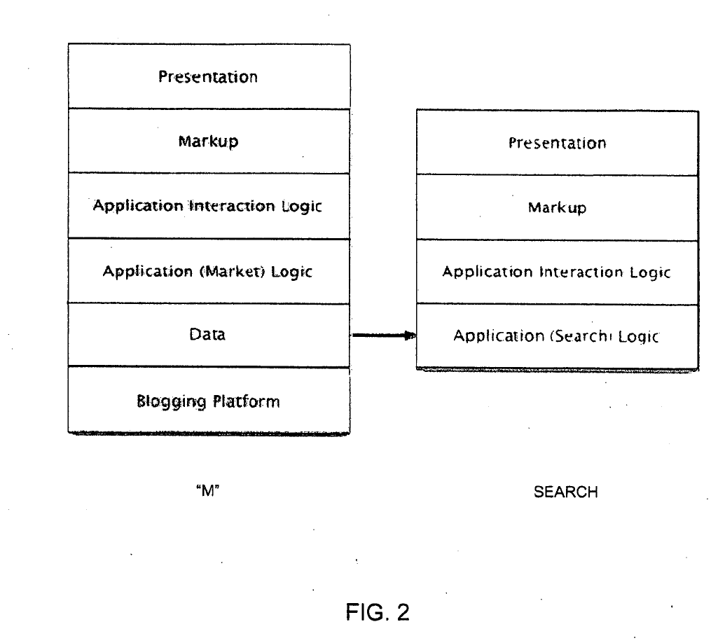

We refer to the above as middleware M. A system consistent with the present invention may include two web applications. M, is one web application (with its associated layers shown in FIG. 2, left side. See below for explanation of layers). The goal of M generally is to generate, through a market application logic (and associated interaction logic, markups and presentations) data which includes (compound) propositions and probabilities and graphs of propositions. This market generated information may then provided as data services to another web application, e.g., a search application, that has its own logic, interaction, markup and presentation layers. This is illustrated in FIG. 2, right side.

### Note on Currencies

As mentioned above, the best outcome is to permit any participant on the general internet to participate on the PMs—an open platform. A preferred embodiment will implement a standard currency for trading on the PMs, that is also not real money (for legal reasons). We therefore assume a single currency for now. As mentioned below, a currency exchange may be provided that could exchange heterogenous currencies to and from an internal one (“SP$”). For the present description, we will assume use of a single standardized currency.

Identities, initial endowment allocations and inflation. Traders will need to have some initial allocation of SP$ endowment. If allocations are determined by uniqueness of IDs then that might create incentives for traders to strategically create many identities so as to increase their budget. Such a situation may lead to an inflation. This may however not be a problem because prices over securities should reflect ordinal, not cardinal, rankings. But if it is a problem, because of some unforeseen strategic consequence (for example, having more money can create an incentive to manipulate bids in different markets so as to influence their outcomes), then two possible solutions may be: a) allocate initial allocations to every unique identity, but the platform periodically readjusts the rates of SP$ or b) continue to allocate a fixed initial endowments in SP$ to unique IDs but make traders internalize some cost of ID creation. For instance, condition the participation on the state of the ID (how long it has been in existence, trading activity—a reputation state). Under such a rule participation is however closed to only those who have managed their IDs, shutting down the market to others (rich get richer). Leveraging the trust relationship between traders maybe one solutions to open up the PMs—long term traders can participate in PMs only if referred through by more persistent traders.

### Presently Preferred Implementations

An illustrative architecture of a mechanism to allocate propositions and quantify their probabilistic information is described in more detail below. This mechanism defines the set of interactions that generate time evolving expectation data. As noted above, we refer to the mechanism as a middleware “M” because, in some embodiments, the mechanism derives its data from the underlying blogging platform and in turn provides data services to other web applications, such as search.

The goal of M is to generate, through a market application logic (and associated interaction logic, markups and presentations) data which includes (optionally compound) propositions and probabilities and graphs of propositions. The system architecture for M is illustrated in FIG. 2. The various layers in the figure are discussed in more detail below.

We group the application logic flow in a preferred embodiment into the following classes of functionalities:
Registration
Market Provisioning
Market execution
Market Clearing and accounting

Below we describe these in terms of stub function calls. We prefix function calls with the namespace of the modules they belong to, followed by the function name. We specify following namespaces:
Presentation
Accounting
DashBoard
   Registration
   Provisoning
   Execution
   Clearing
Graph
MarketCode
Widget
Controller
AppLogic

As shown above Namespaces may be embedded to any number of levels. For instance, namespace DashBoard can be further portioned with provisioning (DashBoard::Provisioning), to modularize the set of dashboard variables that are used to track the state of the provisioning stage of the market. Likewise, DashBoard::Provisioning::SetDashBoardVars refers to subset of variables named SetDashBoardsVars within the dashboard namespace during the provisioning stage.

### Arrival: Landing Page or Widget

From the user perspective, there are two ways a user (a market maker “MM” or a Bidder “B”) interacts with the DPM system:
Direct: In this mode MMs and Bs arrive and interact with the DPM through the DPM's landing page. Participants may
   Arrive independently: via search engines and links
   Arrive via widget download from Blogging platform:
   Arrive via referral, through a redirect call: Bidders who want to participate in the market are redirected by the widget instance code to the landing page.
Indirect: Participants point of entry to the DPM does not involve landing page. Indirect interactions occur only in the case of bidders. Bidders can register with the platform through a widget without visiting the DPM landing page. Bidders may enter bids directly through the widget as well.
   Therefore the DPM presentation layer preferably has at least two sets of logic, one landing page and the other a widget.

### Landing Page

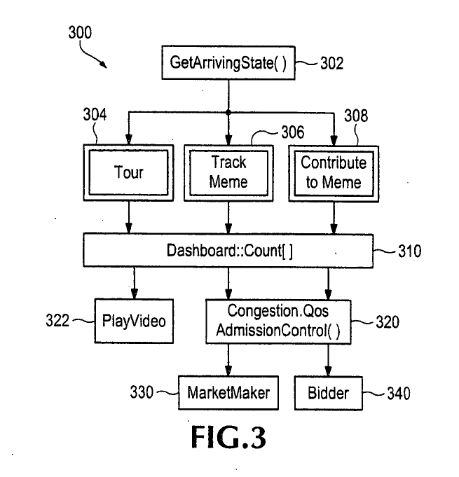

Application logic in an embodiment in the case of direct interactions is as follows. Referring now to FIG. 3, see generally landing page logic flow 300. Users arrive to the DPM landing page and identify themselves as either visitors interested in taking a tour, market-makers interested in creating a market, or bidders. In all cases we preferably record the arriving IP address.

302. Accounting::GetArrivingState( ): Function for M to record IP address (IP). May be used to infer ZIP. Function returns value which will be used to update source-IP and Inferred-ZIP attributes of l[k] data structure (see below).

304. Presentation::Tour( ): Provide a market simulation page, preferably as video 322.

306. Presentation::TrackMeme( ): Message, in form of a button, to Bloggers to be market makers.

308. Presentation::ContributeToMeme( ): Message, in form of button, to potential bidders to choose to participate.

310. DashBoard::Count( ): Function to build cumulative distribution information of user choice types. GetArrivingState( ) 302 provides us with where the users came from. This function provides us with top level dashboard information about where they went to in the system.

320. Controller::Congestion::AdmissionControl(QoS): Admission controller to moderate load levels to satisfy a predetermined QoS level.

330. Presentation::AppLogic::MarketMaker( ): Take market-maker to market-construction resource; described below.

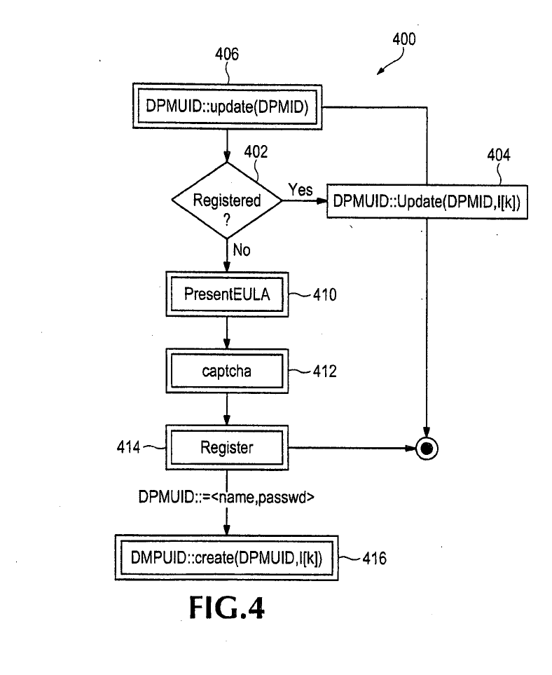

340. Presentation::AppLogic::Bidder( ): Takes bidder to AppLogic::Input::Bid flow for inputting bids; See FIG. 4 re login and registration.

### Arrivals Via Widget

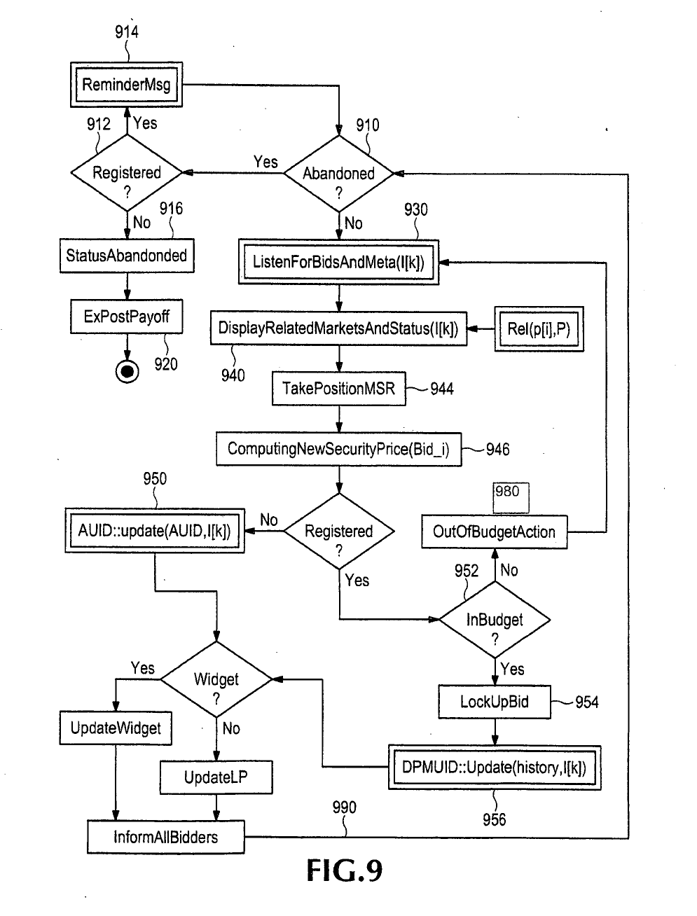

Market Makers widget interactions preferably are restricted to its download onto their blog or other web site. In the case of bidders, the application logic may proceed as follows. Bidder sees the market widget, for example in an iframe on a blog. The last bid may have an up and down arrow superimposed on it. In one embodiment, they can then place bids by clicking on one of these arrows. This event then produces a popup dialogue box where the user can input their bid and the total volume of securities they wish to purchase. Below this bid entry may be some additional information that the system can compute for the user. This information includes:
the probability that the user's bid corresponds to
their winning if event comes true (only for registered users)
their total budget in case of winning and losing (only for registered users)
   These determinations are described in more detail below with regard to FIG. 9.

Registration is discussed next. Registration is necessary for market accounting purposes. However, this requirement is in tension with current web trends where registration process is being minimized. Today users can participate in voting/polling mechanisms quickly and freely without having to register. We therefore want to reduce the transaction costs of Market Makers (MM) and Bidders so as to maximize the total number of interactions in the system.

However, anonymity of the MMs may not be achievable for accounting reasons. Firstly, in the case of a placed widget we cannot easily support unregistered MM interactions for accounting purposes. However, this may not be a problem because most bloggers are accustomed to registration process for widget downloads. Because no interaction is required between the platform M and MMs, MMs can obtain full anonymity if their market is provisioned to be executed on DPM's landing page. On the other hand M would need to know the identity of MM because they are the only entity that can verify the true or false status of the matured security. For these two reasons perfect anonymity of MM may not be implementable in either widget or landing page mode.

Bidders on the other hand can interact anonymously. The strategy in an embodiment is to create a multi-tier market where bidders can trade in four different name spaces:
1. Anonymous User ID (AUID), an anonymous namespace.
2. DPM User ID (DPMUID), a unique name space generated by the platform.
3. Local User ID (LUID), a none-unique name space but scoped for interactions within a given market i. The mapping and ontology rules between LUID and DPMUID is then defined by the platform.
4. Mix of DPMUID and AUID, called DPMUID-AUID.

Transactions in the AUID are anonymous and bidders do not have to register. However, their bids and comments preferably will be partitioned from and not affect the bids of registered participants. DPMUID transactions on the other hand are ones where the market participant has registered with the platform and has been assigned a unique ID. LUID is the local namespace of each individual market.

Finally, we use the mixed DPMUID-AUID as a “holding tank” namespace for registered bidders who have overspent their budget but whom we may want to allow to continue to participate in the market. In one embodiment, we allow this participation only in the AUID namespace. However, like AUID, their bids does do not influence the registered bids, but the platform in a preferred embodiment does hold state to monitor the success of the bidder. If successful, then a new budget may be allocated. See the discussion of budget allocations.

### AUID [Anonymous User ID]

Symmetric anonymity (where both bloggers and bidders are anonymous) is achievable only if all interactions occur on the DPM landing page and the platform does all the accounting. However, in one embodiment, we propose to display dynamic content on the web pages of a blogger. In that scenario, then full and continual anonymity of MMs may be difficult to implement because of market accounting needs. Bidders on the other hand may participate in full anonymity in either landing page or blog widget interactions.

Therefore, a MM who requests a market widget must provide some information so as to enable the platform to provide call-backs so as to update the presentation state of the widget on the blog. The choice of which information to request is a matter of design choice. Two likely candidates are email and blog URL. An email can be used to send the blogger an administration URL. A URL would provide more information because we can harvest much more information about the blog through it.

### DPMUID

Registered participants enable budget accounting. Registration is the process of creating an account on the platform (M). Registration may involve visiting a URI. Registration of bidders may occur before or after market execution. Ex-ante is when all bidders register before markets commence. Ex-post registration occurs proactively when markets are running and unregistered bidders would like to join in.

Blogger/Market-Maker Registration Flow. Referring now to FIG. 4, representative market maker registration logic 400 may be defined by the following flow:
402. Accounting::Registered( ): Boolean test for evaluating whether MM is already registered.
404. Accounting::DB::RegDB::update(DPMUID,l[k]): update the registered user's account with the new market information.
406. Accounting::DB::RegDB::create(DPMUID,l[k]): Create the registered user's account with the new market information.
410. Presentation::Legal::PresentEULA( ): M presents EULA to MMs.
412. Presentation::Security::Captcha( ): unregistered bot exclusion mechanism.
414. Presentation::Accounting::Register( ): Function to elicit name, password and email for account. Returns DPMUID. See 416.

### Bidder Registration Flow

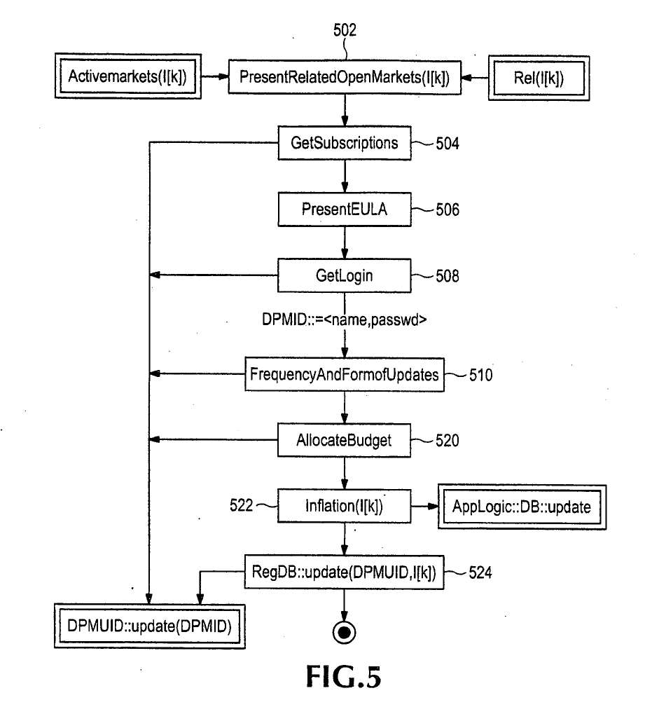

This flow would be invoked in one embodiment from AppLogic::Input::Bid flow. Incoming bids, either indirectly from a widget or directly via the landing page are then checked for membership in either AUID or DPMUID namespaces. Referring now to FIG. 5:
502. Presentation::Output::PresentRelatedOpenMarkets(l[k]): Present to the bidder who wants to be registered for market l[k] all related open markets. Data input is from Graph::Activemarkets and Graph::Rel.
504. Accounting::Input::GetSubscriptions( ): Function to record all markets bidder wants to subscribe to. The Subscription part of a publish-subscribe protocol. Subscriptions to each market are marked as new entries in P[k] column of Accounting::DB::RegDB table (see database discussion below).
506. Presentation::Output::PresentEULA: Same as before
508. Presentation::Output::GetLogin(l[k]): Function to get login information from bidder. Login and password are associated with a uniquely generated DPMUID. When bidder (or market-maker) returns to system and issues the user-name and password that information can be used to pull up their DPMUIDs that holds all their positions.
510. Accounting::Output::FrequencyAndFormofUpdates(l[k]): Function to get how quickly and in what format the bidder wants price updates to markets that bidder is subscribed to. The pub part of pub-sub (See database description below). Frequency choices may include, for example, every time a trade occurs or every X amount of time. Various forms of update can be specified.
520. Accounting::AllocateBudget( ): Function to allocate bidder's initial budget. Updates Accounting::DB::RegDB. See further discussion of budgets below.
522. AppLogic::Inflation(l[k]): Function to compute system wide inflation. Updates AppLogic::DB.
524. Accounting::RegDB::update(DPMUID,l[k]): Update the registered accounts with details of all new account information.

### Market-Maker: Provisioning, Execution, Accounting and Relation Logic

If a user selects “Track Meme” choice (306), then they become a market-maker and set off the following sequence of events. Formally what is being defined is a contract. We can have 3 different types of contracts in DPM:
Binary/winner-take-all (for probability)
Index (for mean)
Spread (for median)

Contracts in a presently preferred embodiment of DPM are binary. This contract links payoffs to occurrence of a specific event. A binary contract is also referred to as a “winner-take-all” contract. Prices of binary contracts represents the market expectation of the probability that an event (corresponding to a proposition) will occur (assuming risk neutrality).

In an alternative embodiment, an index contract payoffs vary in a continuous way based on a number that rises or falls (e.g. “contract l[k] pays $1 for every percentage point of the popularity vote won by Obama”). Prices of such contracts represent a mean value that the market assigns to the outcome.

Below are the set of functions that capture the application logic flow in one embodiment from the perspective of a MM during presentation, market provisioning, execution and accounting. We represent important information about the market instance in the following vector data structure (represented in BNF format):

l[k]::=<p,Price[0],T,Tag,{C}>

where k is the index of the market instance and l, the input to M, is the set of following information:
p, the k-th proposition/“meme” MM wants tracked (mandatory). Value is determined by Presentation::Provisoning::GetProposition( ). Market-participant index (DPMUID and AUID, explained above) provide unique index for each participants. However, there is a 1:N mapping between individuals and markets because each individual can create N markets. Index K therefore needs to be a unique Global ID to differentiate markets by all the individuals.
Price[0], starting price of p (Null, or Float), (optional). The value is set by Presentation::Provisoning::GetStartingPrice( )
T, the deadline or maturity date/time of p (mandatory). The value is set by Presentation::Provisoning::GetDeadline( )
Tag, possibly null, some (keyword) descriptor of the market (optional). The value is set by Presentation::Provisoning::GetTag( ) Tags may be used for relating markets; further discussed below.
{C}, set of constraints on the market (may be implemented as a dictionary). C::<Daily opening and closing of market l, Boolean to determine if a market is private (true) or public (false)>. The constraints are determined by Presentation:: Provisoning::GetConstraints( )
   {whitelist} If the market is private, then determine the names or groups of bidders whitelist who can participate (optional). The value is determined by Presentation::Provisoning::GetAllowedUsers( )
   {blacklist} If the market is public, then determine the names or groups of bidders who cannot participate (optional). The value is determined by Presentation::Provisoning::GetBlockedUsers( )

Following management meta-information may be additional (system generated) attributes of l:
t, the current time proposition was created. This time will be used to do all temporal management of the market.
Source-IP. The value is determined by Accounting::GetArrivingState( ) from top-level landing page. See 302.
Originator::<DPMUID>, see above—unique user identifier.
MarketCode::<CreationTime,Mode>
   CreationTime is a timestamp to allow us to check for staleness. Set by MarketCode::SetCreationTime( )
   Mode::<Widget|LP>. The mode of market is widget or landing page. The value is determined by MarketCode::LP::GenLandingCode( )
State:<created|presented|waiting-to-start|suspended|Open-active|open-inactive |Abandoned|Closed>. State of the market as a Finite State Machine (FSM). The FSM will have state transition rules. Only a subset of functions are permitted to transition the FSM.
   MarketCode::GenCode::ChangeMarketState(State) changes the state of the market based on the available states listed above.
Inferred ZIP
Outcome. The final False/True state of the proposition l[k].

In an embodiment, we represent this data structure in the Accounting::DB::DPMUID namespace. Various representations for this data may be used. Desirable or mandatory characteristics may include scalability and read-write speeds. One possibility is to implement l[k] in memory as a class with initialization methods.

Market Provisioning

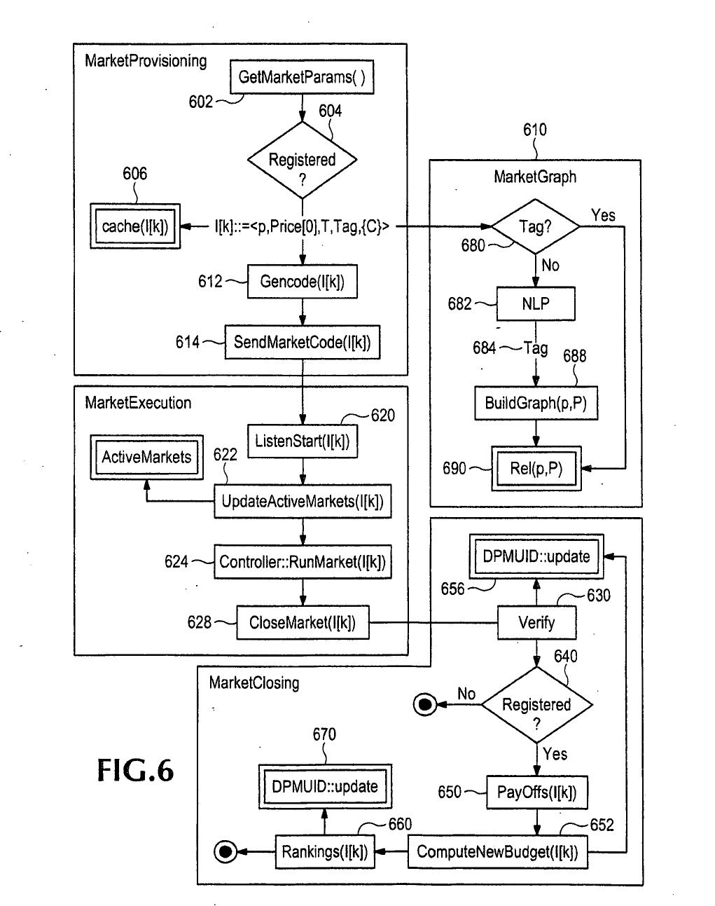

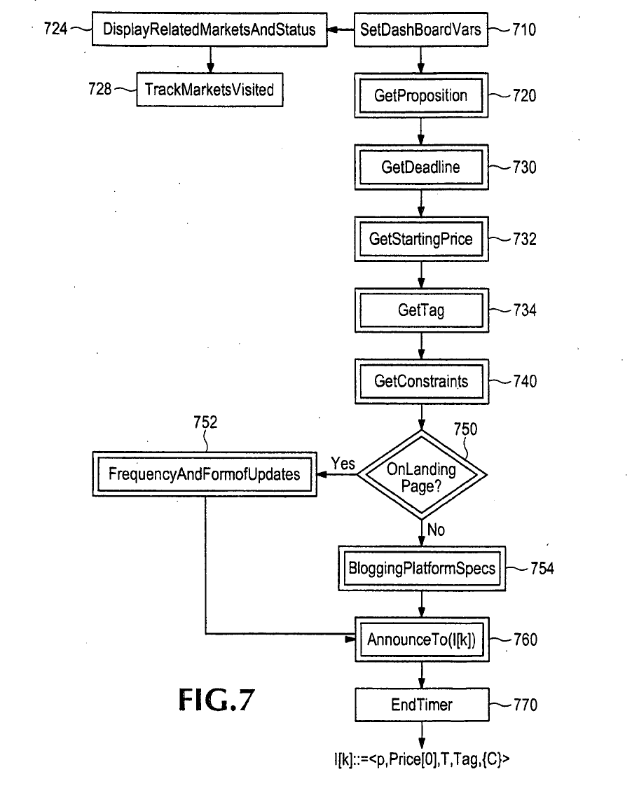

In one embodiment, market provisioning logic proceeds generally as follows. Referring again to FIG. 6, a simplified, high-level flow diagram for market provisioning is shown in the upper left region, beginning with 602, Presentation::Input::GetMarketParams( ): Ask for and read market parameters from MM. Detail of this step is described with reference to FIG. 7 as follows.
710. DashBoard::Provisioning::SetDashBoardVars: Function to set following dashboard variables used for measuring the user interactions:
   a. DashBoard::BeginTimer: Function to measure time it takes user to provide all necessary market data.
   b. DashBoard::Provisioning::SetDashBoardVars::StageCompleted: Function to measure how much of the required information was actually provided by the user. Includes the number of times user was prompted to provide the mandatory information.
720. Presentation::Provisoning::GetProposition( ): UI function to get proposition from user. Post (NLP) [Natural Language Processing] checking may be performed to confirm that proposition fits binary contract format.
724. Presentation::DisplayRelatedMarketsAndStatus( ): In parallel with GetProposition 720, a UI function to display the URI of related markets and outcomes. In some embodiments, display this information to help induce people to create markets by not only showing them other markets, but also tap into the competitive nature of people who think they can do better by showing them other blog results. (See discussion of related markets graph below.)
728. Presentation::TrackMarketsVisited( ): Profiler function that can be used for basis of recommendations. In other words, a record of what markets a user visited, or participated in, may be used to form a profile for that user. Such a profile may be used to identify and recommend other users with similar interests.
730. Presentation::Provisoning::GetDeadline( ): Function to get deadline (maturity) of market. Mandatory.
732. Presentation::Provisoning::GetStartingPrice( ): Function to get starting price of security. Optional. A default starting price may be provided.
734. Presentation::Provisoning::GetTag( ): Function to get descriptive tag of market. Optional.
740. Presentation::Provisoning::GetConstraints( ): Function to get constraints of the system. Optional.
750. Accounting::OnLandingPage( ): Boolean function to check whether market l[k] is going to be on landing page or a widget (read l[k].MarketCode.Mode).
752. If the market is on a landing page, invoke Presentation::Messaging::FrequencyAndFormofUpdates(l[k]): Ask market maker for how frequently and in what format they want the updates about activity in l[k].
754. If the market is not on a landing page, it may be on a blogging platform. In that case, invoke Presentation::Messaging::BloggingPlatformSpecs( ): Function to get the corresponding Blogging platform type.
760. Next, the logic flow in this example calls for Presentation::Messaging::AnnounceTo(l[k]): (optional) Ask the MM for participants who may be interested in l[k]. One possible mechanism is email address book mining of the MM.
770. DashBoard::EndTimer( ): This may be a generic dashboard end-timer function to stop the clock.

At this juncture, a new market l[k] has been defined. Referring again to FIG. 6, the market provisioning logic then proceeds to block 604, Accounting::Registered( ): Boolean to check whether the MM is registered or not; see discussion of “registration” above. Then, update the cache(l[k]) at block 606, GlobalDB::Cache(l[k]): Cache K-th input in to permanent DB which can be read only. DB write may be implemented as an initialization method of l instance. See description of databases below. The database information can be used to form a graph, see 610, further described later.

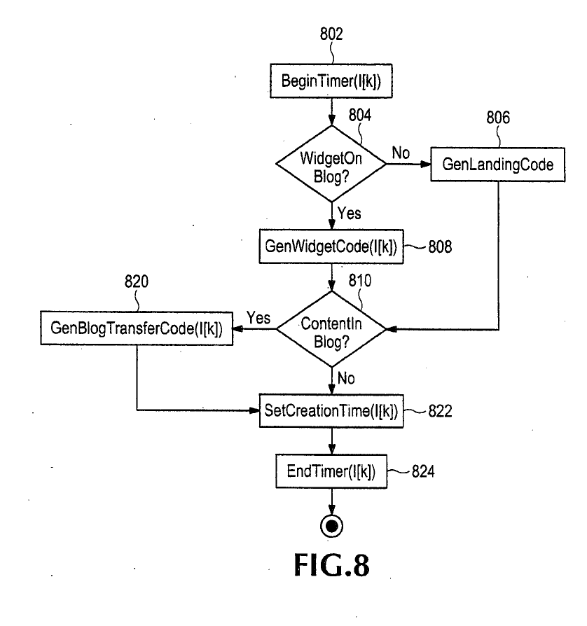

Next at block 612 is the function called MarketCode::GenCode(l[k]): generate widget or landing page code for l[k] market instance. Representative detail is shown at FIG. 8 as follows:
802. DashBoard::BeginTimer(l[k]): Set a timer at beginning of market-code generation process. Together with DashBoard::EndTimer this may be used to quantify QoS metrics; how long it takes to serve users with code.
804. Presentation::MarketCode::WidgetOnBlog(l[k]): The market-maker may be downloading the market code from the blogging widget box or not. In either event give the blogger the choice of code destination. Ask MM whether they want widget on Blog or some private URL off DPM's landing Page for l[k].
806. MarketCode::LP::GenLandingCode(l[k]): Generate HTML code and URL for l[k] on DPM landing page and update l[k]. MarketCode.Mode to LP (Landing Page).
808. MarketCode::Widget::GenWidgetCode(l[k]): Generate widget code and URL for l[k], and update l[k].MarketCode.Mode to Widget.
810. Presentation::MarketCode::ContentInBlog(l[k]): Boolean to test whether MM wants content of l[k] widget to be automatically pushed into blog entries for RSS reader capture.
820. MarketCode::GenBlogTransferCode(l[k]): Generate the market content transfer code for l[k] and append to landing page or widget code (may simply be implemented as a switch variable that includes or excludes this code in market-generation code).
822. MarketCode::SetCreationTime(l[k]): function to timestamp widget or landing page code creation time to catch stale markets in system. Function also changes state of FSM to “created”
824. DashBoard::EndTimer(l[k])

At this juncture, code generation (Gencode(l[k])) 612 is completed, and the market provisioning logic flow of FIG. 6 concludes with SendMarketCode(l[k]) at block 614, and proceeds to Market Execution.

### Market Execution

Continuing with reference once again to FIG. 6, the logic for market execution in one embodiment proceeds to block 620, Controller::ListenStart( ): An Event function that switches state of market instance l[k] from “waiting-to-start” to “open” when event E occurs using, for example, MarketCode::GenCode::SetMarketState(Open). The list of active markets is then updated to include current market. The graph of markets are also updated.

The logic continues at block 624, Controller::RunMarket(l[k]): further discussed below. And finally, the logic moves to 628, Controller::CloseMarket(l[k]): Changes state of l[k] from “open” to “closed”.

### Market Closing

At the bottom of FIG. 6 is a simplified logic flow diagram of a market closing process in the illustrated embodiment.
630. AppLogic::Verify(l[k]): Verify the True/False outcome of the Kth market. Note, the market may have ended in advance of the actual realization of the event that the security tracks. Verification mechanism may include email/SMS/callback/etc. In a preferred embodiment, the corresponding market maker has to verify and declare the outcome of his or her market. Function also updates the “outcome” record of l[k].
640. Accounting::Registered( ): Boolean returns True if bidder in l[k] are registered.
650. AppLogic::PayOffs(l[k]): compute payoffs to registered bidders for k-th market instance of 1.
652. AppLogic::ComputeNewBudget(l[k]): Compute the new global budgets of registered bidders in response to the computed payoffs.
656. DPMUID::UpdateBudgets( ): Store in long-term storage the new budgets of participants.
660. AppLogic::Rankings(l[k]): Compute the ranking of each bidder and blog.
670. DPMUID::UpdateRankings( ): Update the rankings of individuals and blog

### Market Graph

The term “graph” here preferably refers to a data structure. A graph may be developed to determine, store and leverage relationships among markets, for example to make recommendations to users, as further discussed below.
680. Referring once again to FIG. 6, the upper right block 610 illustrates marketgraph logic flow. Here, decision 680 Accounting::Tag( ): Boolean returns value False if value of Tag of l[k]==Null.
682. Graph::NLP( ): If Tag==Null then parse l for keyword, for example using a predetermined ontology O. Block 682 “NLP” refers to one embodiment in which Natural Language Processing may be used as a way to do tagging. In other embodiments, user tagging may be used, or a combination of the two, to arrive at useful tags 684 for a proposition.
688. Graph::BuildGraph(p,P): Compute the relationship between p and all observed set of markets P and the derived tag 684.
690. GraphDB::Rel(p,P): update GraphDB with “relational predicate”.

Referring now to FIG. 9, a representative logic flow is shown for running a market:
910. (optional) Controller::Abandoned(l[k]): Test for abandoned markets. In one embodiment, defining the abandoned function may be considered equivalent to defining a classifier that implements a discrimination rule. One potential discrimination rule is a probability function that grows exponentially closer to 1 as deadline of market approaches, and takes into account the number and time distribution of bids. If true then function changes status, for example via a logical finite state machine FSM from open-suspended-abandoned-closed.

In some cases, some markets may naturally converge very quickly to a consensus viewpoint (Will Bush be impeached?) and then stay that way for a long time (till January 2009), but still be “alive” in the sense that it can't be closed, and everyone who bet in it wants it to stay alive. But there may be no new bets for some time. Various classifiers may be developed that can discriminate between truly abandoned vs. quickly converged markets. That said, a market that converges very quickly is also of little information interest because it converges to what everyone agrees to very quickly. So in a way, although not “abandoned” these markets are of low information value.
912. (optional) Accounting::Registered( ): Boolean returns True if bidder in l[k] is registered.
914. (optional) Presentation::RemindMsg(l[k]): Remind registered (and abandoned) bidders of the market status.
916. (optional) Accounting::StatusAbandoned(l[k]): Function to update the FSM status to “abandoned”.
920. (optional) AppLogic::ExPostPayoff(l[k]): In a preferred embodiment, we don't want to just let an abandoned market “drop”. It would be preferred in some embodiments to ensure that we still get some signal in the market even though it is abandoned. Function to hold state so that the bidder who was closest to the realized outcome is paid off.
930. Presentation::Input::ListenForBidsAndMeta(l[k]): Open-loop event-driven function to receive bids and meta information. Invokes the same AppLogic::Input::Bid functions as landing page “ProvideMeme”.

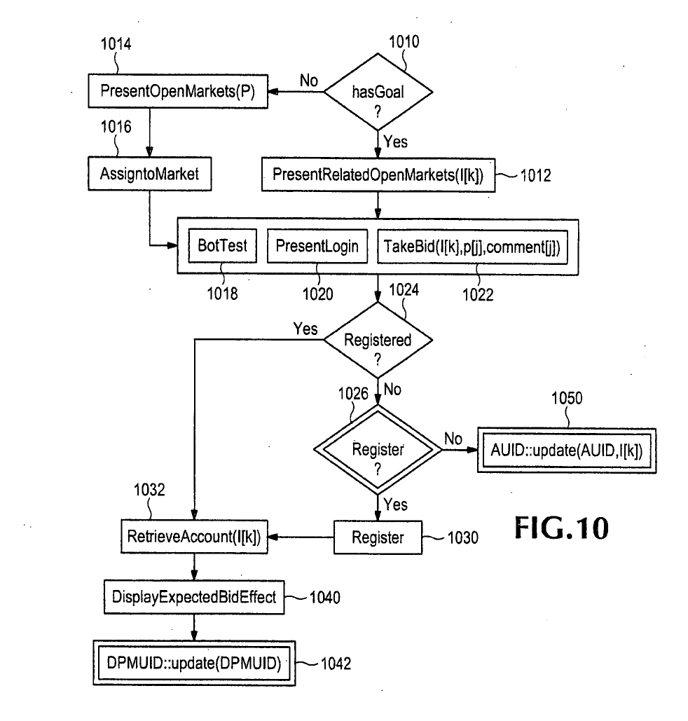

More detail of this function 930 is shown in FIG. 10 as follows:
1010. Presentation::hasGoal( ): Boolean function that determines whether bidder has a target market in mind. Mechanism of determination could be whether bidder came from menu navigation on landing page (implying no target market) or whether it came via a widget call (a call that will have appropriate market ID)
1012. Presentation::Output::PresentRelatedOpenMarkets(l[k]): If user has particular market in mind then present all related markets (using RelDB—see 610 and related text). Most likely the bidder who is interacting with a widget executes this part of flow.
1014. Presentation::Output::PresentOpenMarkets(l[k]): If user has no particular market in mind then present all open markets. Most likely the bidder who is exploring the landing page executes this part of flow.
1016. AppLogic::AssigntoMarket(l[k]): If bidder chooses a market, then register the user with that market l, given the constraints C of l stated by the corresponding market maker.
1018. Presentation::BotTest( ): We want to give bidders the ability to automate bidding, but we want to exclude unregistered third-party bots that may be malicious.
1020. Presentation::Output::PresentLogin( ): Simultaneously present to the bidder fields captcha, login and bid placement. PresentLogin allows user to login to their account and have their bid accounted for.
1022. Presentation::Output::TakeBid( ): Function to capture the bidder's bid at price p. Current price p represents the price of first unit or share. Bidders can then specifies either total quantity of l[k] they would like to purchase, or average price they would like to pay (reflecting the probability of the event). This information will be used by the Market Scoring Rule (described below) to compute average price (if bidder chose to specify volumes only) or volumes (if user specified average price) and total price that needs to be paid. User also may leave a comment at time t.
1024. Accounting::Registered( ): Boolean function to check whether bidder is registered.
1026. Presentation::Output::Register( ): Boolean function for asking bidder if they want to register.
1030. Accounting::Bidder::Register(l[k]): Function for registering bidder (see Accounting::Bidder::Register in bidder registration flow).
1032. Accounting::RetrieveAccount( ): Function to retrieving bidder's account.
1040. Presentation::Output::DisplayExpectedBidEffect(l[k]): Presentation function to display to the bidder the expected effects of their bid on their budget. Expected in that it computes the rise or fall of budget if bid is successful or not respectively at maturation time of security.
1042. Accounting::DB::RegDB::update(l[k]): Function to record the bid amount, volume and metadata a registered bidder placed. Note, this amount maybe different to the actual accepted bid.
1050. Accounting::DB::AUID::update(l[k]): Function to record the bid amount volume and metadata an unregistered bidder placed.

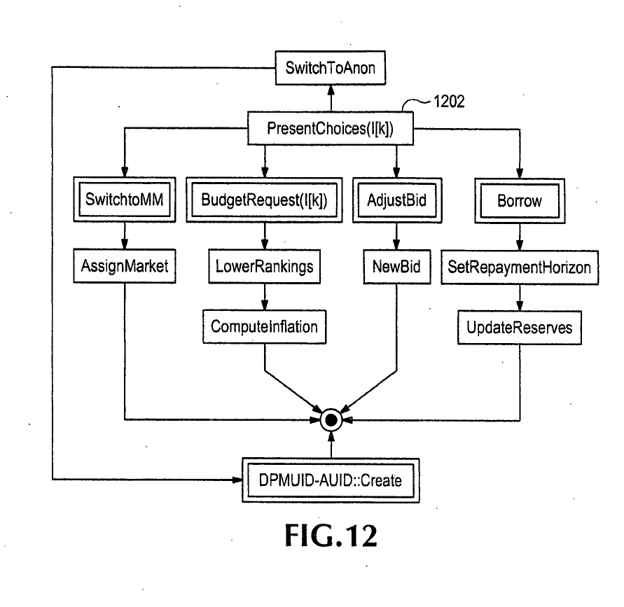

Returning now to FIG. 9, following the function ListenForBidsAndMeta 930, the running logic proceeds as follows:
940. Presentation::DisplayRelatedMarketsAndStatus(l[k]): General principal is to show (on either widget or landing page) related and active market information anytime user interacts with the system. Another chance to present to the user (either MM or Bidders) this information.
944. AppLogic::TakePositionMSR(l[k]): Execute (ask-bid) order through Market-Scoring Rule application described below. In some embodiments, the System may take a position too at some predefined level to add “noise”.
946. AppLogic::ComputeNewSecurityPrice(l[k]): Compute the new market price for l[k] given bid from AppLogic::TakePositionMSR.
950. Accounting::DB::AUID::Update(l[k],Bid,t): Update the anonymous DB associated with l[k] with bid, volume and meta information.
952. AppLogic::InBudget(Bid_i): If bidder is registered then check to see if bid is within budget. In one embodiment, rules would provide for both cases where budget approaches and reaches zero. We can provision for the former case by proactively signaling the effect of each bid on the budget (in both cases if bids transpire to be right or wrong). This is achieved in AppLogic::Input::bid with the Presentation: Output::DisplayExpectedBidEffect function.
980. If the bid is out of budget, see block 980, various alternatives are discussed below with reference to FIG. 12.

If budget actually is replenished then choices of actions are:
replenish budget at some cost, where cost=[0,X]
make loans
exclude from the market
switch to anonymous bidder
switch to MM and pay MMs

First two choices maybe too cognitively costly for some users. Exclusion may in fact be the right strategy if market has scaled because we don't want people to be consistently bad at predicting in the system. In one alternative strategy the system may switch a user to the anonymous pool of bidders but keep state on their bidding. If they do well in that pool then we can give them a budget. The simplest action to take if user is out of budget maybe simply to exclude the user. Prior to that we would limit a bid to the max that a player has uncommitted at a given point in time.

Another option is to create an economy for market-makers who get paid in some value accounting system. Not only will that give bloggers incentives to procure points for creating markets, but we can give bidders who have shot through their budget an opportunity to amass “money” in other ways in the system. Preferably, we would require the presentation layer to proactively inform bidders of the expected effect of their bids on their current budget.

In an embodiment, a minimum budget floor is selected. If a bidder has reached this level (say 10 c), then they can only bid 10 c on any proposition. If they win, they win only 10 c and if they lose they lose nothing (i.e. there is only upside if at 10 c).

Referring now to FIG. 12, the application logic in an embodiment, If a bid is not within budget, may then prompt bidder for action, as follows.
1202. Presentation::Output::PresentChoices( ): Present four choices corresponding to the following:
1204. Presentation::Input::SwitchtoMM(DPMUID): Registered user requests or is directed to becoming a MM.
1206. Presentation::Input::BudgetRequest(DPMUID): Registered user requests a budget update today in return for lowering of rankings on the overall system of predictors.
1208. AppLogic::LowerRankings(BudgetAdjusted): Lower the bidders rankings in proportion to the amount borrowed.
1210. AppLogic::ComputeInflation(AllocatedBudget): Recompute inflation given total amount of money in the system. Recalibrate the currency accordingly.
1220. Presentation::Input::AdjustBid(NewBid): Registered bidder chooses to replace bid within current budget.
1230. Presentation::Input::Borrow(NewFunds): Registered bidder does not request a new budget (unlike BudgetRequest) but instead is given a loan with a repayment horizon. Like requesting a budget the user incurs a penalty (of again losing rankings) if repayments are not within the stated payment horizon.
1232. AppLogic::SetPaymentHorizon(DPMUID): Set the horizon of loan repayment
1234. AppLogic::UpdateReserves( ): Update the currency reserves.
1240. Accounting::DB::SwitchToAnon(DPMID): Switch bidders with out of budget levels to the DPMID-AUID namespace. Creates Accounting::DB::DPMUID-AUID table entry. At block 1242 the anonymous database is updated by creating a new AUID.

Referring again to FIG. 9, if the bid is within budget (952) the application logic proceeds as follows:
954. Accounting::LockUpBid(l[k]): If bid m is within budget then deduct the corresponding total cost from the total current budget (see below). Bidder now has cash holdings and security holdings.
956. Update history DPMUID::Update(history,i[k]) for the market.
958. If the bid comes from a widget, update the widget at block 960. If not from a widget, update the landing page at 962. And then, inform all bidders at 970: Presentation::Output::InformAllBidders(l[k]): Inform all the registered bidders of the new market activity (prices and meta information), given the dissemination frequency constraint. The running market logic then loops via 990 back to check for abandonment 910 as described above.

Remaining functions briefly include the following:

AppLogic::VerifyPresentation::Output::Verify(l[k]): Verify whether proposition l[k] was true or false at time of maturation. Recall, one dimension of transaction cost minimization was evaluation costs. The solution we propose is to allocate this cost to MM who created the markets in the first place, giving them, rather than the platform, the monopoly rights over evaluation. This not only reduces platform transaction costs but also reduces strategic possibilities by coalition of players. Therefore we message the MM who created l[k]. Updates the outcome variable of Accounting::DB::DPMUID table.

AppLogic::Payoffs(l[k]): Compute for each registered bidder their payoffs, which may be the total volume of their security holdings over l[k] multiplied by the payoff price advertized on the face of security.

AppLogic::ComputeNewBudget(l[k]): Compute for each registered bidder their new budgets given their payoffs. That is cash holdings are adjusted according to security holdings payoffs.

AppLogic::Rankings: In one embodiment, Player A has n dollars before placing a bid, this is the score that they have in the rankings. They then place m dollars on a proposition, so they have n−m dollars and m dollars worth of some proposition. Now if their proposition does well (more bids on it) and their m dollars worth of proposition becomes worth M dollars. They have (n−m)+M score in the ranking and presumably a higher position.

We next describe the Market Scoring Rule (MSR) algorithm in a preferred embodiment. We access data using the “.” notation to signify OO object methods. We specify unique IDs for each registered bidder by DPMUID. We then define two quantities as follows:

The overall budget of a player j is (DPMUID.budget). A proposition (e.g. “Helmets will be the height of fashion by 2010”) can be either true or false at 2010. We define true and false outcome as O1 and O2, respectively. Security 1 is described as, “pays $1 if O1”. Security 2 is described as, “pays $1 if O2”. There are discrete quantities of security1 and security2. Total numbers of security1 and security2 are called total number of outstanding shares. We refer to them as q1 and q2 respectively. An individual user can have some proportion of q1, q2. The current security holdings of outcome O1 of a player j (DPMUID.holdings.O1)

We also define the following Market Message Interfaces:

```
    join: /* interface to join the market instance l[k] */
        message.type=join
        message.UID
    bid: /* interface to BidEntryForm, from MarketViewChart. message
has following properties */
        message.type=bid
        order.position
        order.outcome
        order.quantity
```

A Cost Function c=b*log(ê(q1/b)+ê(q2/b)) where b is a liquidity factor; q1 is the total number of currently outstanding shares of the true outcome security; q2 is the total number of currently outstanding shares of the false outcome security.

Standard price function price=(ê(q1/b))/(̂(q1/b)+̂(q2/b)).

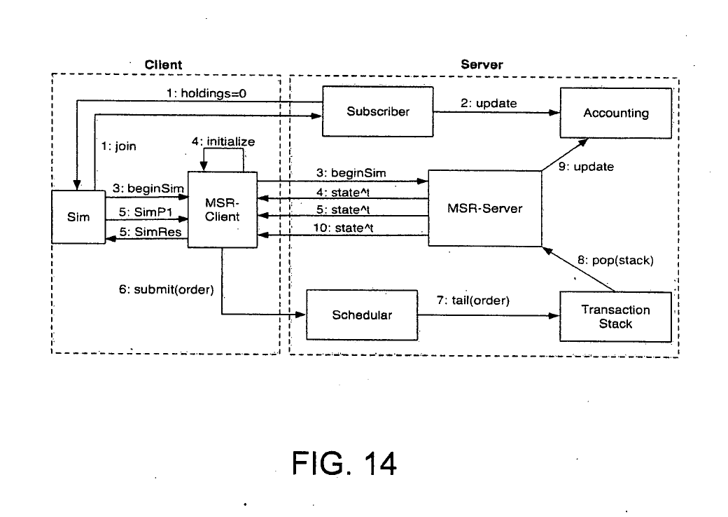

FIG. 14 represents the execution logic and messaging between various components of the system in one embodiment. The sequence is as follows:
1. Users “join” the market after seeing (on the MarketView or widget) P1 the current probability of outcome O1 (the market probability). Their holdings of O1 and O2 (DPMUID.holdings.O1 and DPMUID.holdings.O2) are initialized to 0.
2. Their DPMUIDs are then registered in accounting (after registration or login). A join message creates a “watching” state for DPMUID in the DB.
3. Users then click on the market button (on widget or Landing Page). This sends a beginSims signal to the MSR (Market Scoring Rule)-server.
4. Server side MSR then presents and updates the widget/LP with the latest market state information (statêt). State information at time t is defined as:
   (P1,q1,q2,b), the current market probability, total outstanding shares of q1 and q2 and b, the liquidity parameter of the MSR
This information is used by the local client side (MSR-client) to compute SimRes (see below) and are shown as the global variables in the pseudo-code below. At this point the client side MSR also initializes all the local variables.
5. User then interacts with the client-side MSR. Users have different degree of coupling between the UI (called “sim” in FIG. 14) and client-side MSR.
   Some users want to play around with the market UI and explore their bid and its effect on the system. User is then tightly coupled to the MSR, creating a cycling closed-loop. These users play around with the UI that represents their estimated probability, SimP1, of proposition. The MSR takes as input the SimP1 chosen by the user (and the global variables given by statêt) and computes SimRes which represents:
      SimRes=(TotalSimCost,SimBudget, BudgetTrue,BudgetFalse,Rank,RankTrue), where
         TotalSimCost is the cost of choice SimP1
         SimBudget is the effect of SimP1 on current budget
         BudgetTrue is the effect of SimP1 on budget if proposition transpires to be true and
         BudgetFalse is the effect of SimP1 on budget if proposition transpires to be false
         Ranking is the effect of SimP1 on current rankings of user and
         RankTrue is the effect of SimP1 on current rankings of user if proposition is true
   Other users on the other hand do not want to play around with the UI and explore their bid and its effect on the system. They simply want to leave a bid and exit. These users are therefore not tightly coupled to the MSR. They specify a single SimP1 (on the BidEntryFormBasic). The MSR takes as input the SimP1 chosen by the user (and the global variables given by statêt in step 3) and computes a simpler SimRes which represents:
      SimRes=(TotalSimCost,SimBudget)
6. User (Of either type) then submits their bid. This hid is called an order. Order has following parameters to the message in a preferred embodiment:
   (DPMUID,statêt,SimP1,Simq1,Simq2,SimBudget,TotalSimCost)
      where statêt records the P1, q1 and q2 as seen last by the client.
7. Order is then sent to the server who schedules the order into a FIFO que. The order in placed into the tail of the que.
8. Control is then passed onto the transaction execution unit which pops the top order in the stack.
9. This order is then sent to the MSR which commits user's order (i.e. updates their budgets and holdings of q1 and q2) to the DB. The DPMUID changes state from “watching” to “active”.
10. The resulting new state of the system (statêt=P1,q1,q2), because of committing the order of the user, is then pushed to all clients who have subscribed to that market.

### Synchronicity Considerations

Distribution means there will be two problems to deal with:
1. Latencies: in updating the state of widgets/LPs which will invalidate outgoing and incoming orders.
2. Coordination: When multiple bidders' orders are in contention.

There are three points in the MSR execution where these problems will arise:
1. At “simulation” time. Users will experience state changes while other transactions are committed by the serverside MSR. The effect of this is that the cost of the bidder's current bid (probability level) will change dynamically without user doing anything. Therefore what needs to be done is to alert the user of the change in two quantities, P1 (the market probability) and cost of their choice SimP1
2. At “submit” time. State of widget/LP is updated but user goes to place order and has not seen that the state change. Solution to this problem is to re-compute the new cost for the specified SimP1 and present a confirmation dialogue box to the user.
3. At transaction time. User's order (order_i) has been placed on the server-side. However, there are other orders (<order_j>) ahead of the user's order in the que. Committing other preceding orders in the stack changes q1 and q2 (the total number of outstanding shares of security1 and security2). Therefore the cost to the user for their old order order_i changes. In the best case there is only one other order ahead of the order_i. In the worse case there are infinitely many.

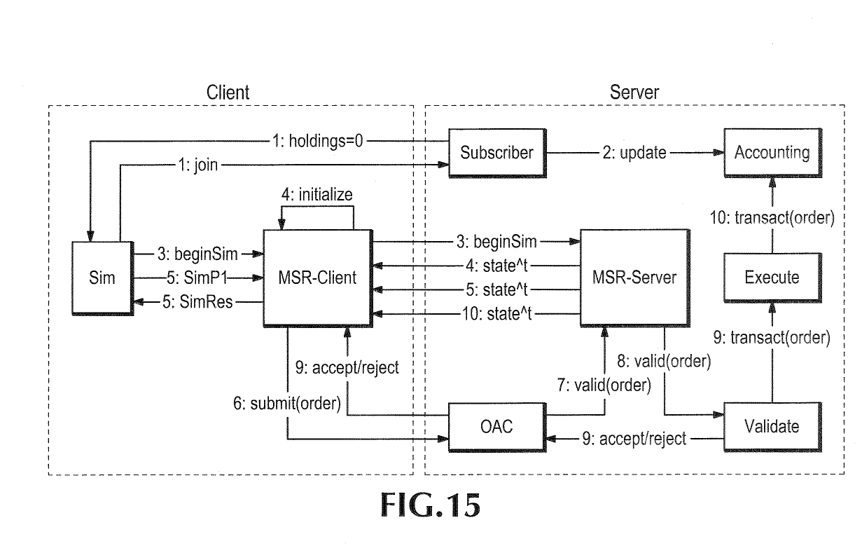

Potential solutions to this problem include the following. Refer to FIG. 15.
a. Allow stack to hold multiple order flows and message users whose order costs are affected when orders ahead of the que are satisfied. This is naturally communication costly, specially as end of the market approaches
b. Transact orders automatically if users budgets support the required SimP1. Although from an application perspective this is good, because communication is less intensive, this solution does however results in less transparency which may not be desirable from user perspective.
c. Reduce most SimP1 and messaging complexities by allowing users to specify relatively more complex “limit order” rules. The problem with this solution is that few users will be able to understand the concept of limit orders.
d. Serialize the order entry (to the server-side MSR) through an admission-controller: Limit transaction stack on the server-side to capacity of only one order at a time (see FIG. 15). Then when users submit order they get a confirmation box (to catch case 2 problems above) they then see a progress bar (“placing your order”—much like priceline, etc). While progress bar is showing the clientside MSR talks to the OAC (Order Admission Controller), which checks to see if other orders are being processed. If not then users order is sent to the server-side MSR to check for validity. We need to do this to check for the case where the upload is faster than the download (i.e. information from client to server, the order, is faster in arrival, than the updated statêt information from the server to the client). The order is then sent to the validator which checks that the P1 associated with the order is in sync with the current statêt. If so the order is sent for execution and the user UI shows “order successful” message. The execution of the order then changes the accounting DB entry field (the bidders budget) and creates a new state (P1′,q1 ′,q2 ′), which needs to be communicated to all clients (link 10). The OAC, MSR-Server, Validate and Execute modules are all components of the MSR in the code below. If there are other orders by other bidders before the current order then that user's order is rejected (because of other orders ahead in the que) and is notified of change of state (“Someone just changed put money in. You'll need to put more money to satisfy your order”). The user is then given a choice of:
   i. sticking with their SimP1 choice but facing a different cost (“i.think the same, but the money I need to put is: XX”)—the system can compute these (SimP1,Cost) pairs, or
   ii. go back to the BidEntryFormAdvanced to recomputed their SimP1

### APPLICATION LOGIC, EXAMPLE 1

In this example, registered bidders only are permitted, binary securities, no tag, no short selling, and the user specifies probabilities rather than quantities of securities. The user interface is further discussed below. A preferred sequence of order entry (line 5 onwards) is the following. Bidder first sees the time series market data for only O1 (not O2) on a MarketView page. The bidder clicks either an up or down arrow on last previous bid and is taken to a new page called BidEntry page. First we present only probability logic, not quantities.

| | |
|---|---|
| 1. | (K,O1,O2, deadline) = specify(market) /*K is market instance */ |
| 2. | q1=q2=0 /* quantities of outstanding shares O1 and O2 respectively */ |
| 3. | increments = 1 /* variable for controlling granularity of series generated from min to max of probability */ |
| 4. | While(time < deadline) |
| 5. | { |
| 6. | /*-----------------------------------------MarketView Page-----------------------------------------*/ |
| 7. | O1.price = (e\hat{ }(q1/b)) / (e\hat{ }(q1/b) + e\hat{ }(q2/b)) |
| 8. | O2.price = (e\hat{ }(q2/b)) / (e\hat{ }(q1/b) + e\hat{ }(q2/b)) |
| 9. | updateMarketView(time,O1.price) |
| 10. | message(DPMUID,join,K) /*get UID of registered bidder that wants to participate in market K */ |
| 11. | /*-------------------------------------user clicks on up/down key on last bid -------------------*/ |
| 12. | /* user clicks on up arrow first on MarketView page, meaning user believes probability will go up*/ |
| 13. | /* We use this ordinal information to compute the min and max limits of a slider button for |
| 14. | the upcoming cardinal information on BidEntry Form */ |
| 15. | if(buttonPress==”up”) |
| 16. | { |
| 17. | position=”buyer” |
| 18. | max-buy-slider=maxslider(K,O1,DPMUID.Budget) /* compute max probability given current budget |
| | */ |
| 19. | min-buy-slider=O1.price /* min slider is the current price of O1 (as computed by the price, and not |
| | the cost, function) */ |
| 20. | series = minToMaxSeries(K,min-buy-slider,max-buy-slider,increments,O1,DPMUID) |
| 21. | } |
| 22. | if(buttonPress==”down”) |
| 23. | { |
| 24. | position=”seller” |
| 25. | if(DPMUID.Holdings.O1 != 0) /* no short selling & case 1 above */ |
| 26. | { |
| 27. | max-sell-slider=maxslider(K,O1,DPMUID.Holdings.O1) /* compute min probability bidder can |
| | specify |

| | |
|---|---|
| 28. | given their current holdings of O1 */ |

| | |
|---|---|
| 29. | min-sell-slider=DPMUID.Holdings.O1+1 |
| 30. | series = minToMaxSeries(K,min-buy-slider,max-buy-slider,increments,O1,DPMUID) |
| 31. | } |
| 32. | if(DPMUID.Holdings.O1 = 0) /* case 3 above*/ |
| 33. | { |
| 34. | max-buy-slider=maxslider(K,O2,DPMUID.Budget) /* if no holdings of O1 then become buyer of |
| | O2 */ |
| 35. | min-buy-slider=O2.price |
| 36. | series = minToMaxSeries(K,min-buy-slider,max-buy-slider,increments,O1,DPMUID) |
| 37. | } |
| 38. | } |
| 39. | /*--------------------BidEntry Page - simulation stage -----------------------------------------------*/ |
| 40. | lastChoice=[ ] |
| 41. | while(action!=submit) |
| 42. | { |
| 43. | currentBid=slider(currentvalue) /* read the current value of slider */ |
| 44. | q = retrieveQuantities(DPMUID,K,position,Series,currentBid) /* recall (from “series”) quantity |
| 45. | corresponding to |
| | currentBid on slider */ |
| 46. | budget=BidEffectOnCurrentBudget(DPMUID,position,currentBid,q) |
| 47. | expectedBudgetTrue = expectedBudget(DPMUID,K, |
| 48. | expectedBudgetFalse = expectedBudget(DPMUID,K, |
| 49. | rankings(DPMUID,K) /* current rankings within market instance K */ |
| 50. | rankings(DPMUID,K) /* current rankings within market instance K */ |
| 51. | append([currentBid,q,budget,expectedBudgetTrue,expectedBudgetFalse],lastChoice) |
| 52. | display(O1.price,lastChoice) |
| 53. | } |
| 54. | /*--------------------BidEntry Page - submit stage -------------------------------------------------*/ |
| 55. | if(O1.price!=O1.price) |
| 56. | } |
| 57. | /*-----------------------End of Market--------------------------------------------------------------*/ |
| 58. | verify( ) |
| 59. | settle( ) |
| 60. | rank( ) |
| 61. | } |
| 62. | |

### APPLICATION LOGIC, EXAMPLE 2

In this example, the features include the following: 1) registered bidders only, 2) open (no constraints), 3) binary securities, 4) no tag, 5) no short selling, 6) user specifies probabilities and not quantities, and 7) no ex-ante min-max computation (b/c of potential price changes).

A preferred sequence of order entry (line 5 onwards) is the following:

| | |
|---|---|
| 1. | Bidder first sees the time series market data for only O1 (not O2) on MarketView page. |
| 2. | Bidder clicks either an up or down arrow on last previous bid and is taken to a new page |

called BidEntry page.

| | |
|---|---|
| 3. | In one embodiment, the page presents only probability logic, not quantities. |
| 4. | The BidEntry form invokes the logic beginning at line 9 below. |
| 1. | /*---------------------------------Market Provisioning---------------------------------------------------*/ |
| 2. | (K,O1 O2, deadline) = specify(market) /*K, O1 and O2 are indexes of the market instance, |
| | positive outcome and negative |
| 3. | outcomes respectively */ |
| 4. | q1=q2=0 /* quantities of outstanding shares O1 and O2 respectively */ |
| 5. | increments = 1 /* variable for controlling granularity of series generated for searching quantities given |
| | prices */ |
| 6. | time = currenttime( ) |
| 7. | K.O1.price.time = (e\hat{ }(q1/b)) / (e\hat{ }(q1/b) + e\hat{ }(q2/b)) /* price function to determine the current price of |
| | outcome 1 */ |
| 8. | K.O2.price.time = (e\hat{ }(q2/b)) / (e\hat{ }(q1/b) + e\hat{ }(q2/b)) /* price function to determine the current price of |
| | outcome 2 */ |
| 9. | updateMarketView(K.O1.price.time) |
| 10. | /*--------------------------------------------Market Execution-----------------------------------------*/ |
| 11. | While(time < deadline) |
| 12. | { |
| 13. | if(messageBuffer!==[ ]) |
| 14. | { |
| 15. | while(message = pop(messageBuffer)) /* FIFO: first message in que */ |
| 16. | { |
| 17. | DPMUID = message.K.UID /*get UID of registered bidder that wants to participate in market |
| | K */ |
| 18. | switch(message.K.type): |
| 19. | join: |
| 20. | DPMUID.holdings.K.O1= DPMUID.holdings.K.O2 = 0 /*intialize initial holdings*/ |
| 21. | up: /* Message generated from MarketView page when user clicked on up arrow of last bid */ |
| 22. | position=”buy” |
| 23. | sendtoBidEntryForm(DPMUID,K,position,time) |
| 24. | down: |
| 25. | position=”sell” |
| 26. | sendtoBidEntryForm(DPMUID,K,position) |
| 27. | order: /* Message generated from BidEntryForm page when user submits a bid */ |
| 28. | { |
| 29. | [q1,q2]= message.K.DPMUID. |
| 30. | K.O1.price.Ordertime = (e\hat{ }(q1/b)) / (e\hat{ }(q1/b) + e\hat{ }(q2/b)) |
| 31. | K.O2.price.Ordertime = (e\hat{ }(q2/b)) / (e\hat{ }(q1/b) + e\hat{ }(q2/b)) |
| 32. | updateMarketView(K.O1.price.Ordertime) |
| 33. | } |
| 34. | } |
| 35. | } |
| 36. | elseif(messageBuffer==[ ]) time = currenttime( ) |
| 37. | } |
| 38. | /*-------------------------------------------End of Market---------------------------------------*/ |
| 39. | verify( ) |
| 40. | settle( ) |
| 41. | rank( ) |
| 42. | } |

sendtoBidEntryForm(DPMUID,K,position,time)
{

| | |
|---|---|
| 1. | /*-------------------------------------------BidEntry Page - simulation stage ----------*/ |
| 2. | lastChoice=[ ] |
| 3. | while(action!=submit) |
| 4. | { |
| 5. | currentBid=slider(currentvalue) /* read the current value of slider */ |
| 6. | q = retrieveQuantities(DPMUID,K,position,Series,currentBid) /* recall (from “series”) quantity |

| | |
|---|---|
| 7. | corresponding to |

| | |
|---|---|
| | currentBid on slider */ |
| 8. | budget=BidEffectOnCurrentBudget(DPMUID,position,currentBid,q) |
| 9. | expectedBudgetTrue = expectedBudget(DPMUID,K, |
| 10. | expectedBudgetFalse = expectedBudget(DPMUID,K, |
| 11. | rankings(DPMUID,K) /* current rankings within market instance K */ |
| 12. | rankings(DPMUID,K) /* current rankings within market instance K */ |
| 13. | append([currentBid,q,budget,expectedBudgetTrue,expectedBudgetFalse],lastChoice) |
| 14. | display(O1.price,lastChoice) |
| 15. | } |
| 16. | /*------------------------------------------BidEntry Page - submit stage----------------------*/ |
| 17. | if(O1.price!=O1.price) |
| 18. | } |
| 19. | |

Float maxslider(Oi,Field):
List minToMaxSeries(K,min-buy-slider,max-buy-slider,increments,O1,DPMUID):
/* function to create a linear series between a min to a max. Granuality of series is dictated by variable
increments” */
/* Used for open question 2 */

| | |
|---|---|
| 1. | i[k] = ”Obama wins 2008 nomination” |
| 2. | O1 = l[k].verb /* get verb describing outcome 1 of market instance k (e.g. wins) */ |
| 3. | O2 = l[k].verb.inverse /* compute the inverse outcome 1 of market instance k (e.g loses) */ |
| 4. | q1 = q2 = 0 /* total number of outstanding shares for O1 and O2 */ |
| 5. | T=l[k].T /* get deadline of market instance k */ |
| 6. | l[k].Participants = [ ] /* initialize market instance participants to empty list */ |
| 7. | q = p = 0 /*initialize quantity and price offers to zero */ |
| 8. | BudgetLowerBound = 10 /* setting the lower bound of the |
| 9. | while (t < T) /* while current time t < deadline T */ |
| 10. | { |
| 11. | if(message.type==join) |
| 12. | { |
| 13. | DPMUID = messageUID /*get UID of registered bidder who wants to participate in l[k]*/ |
| 14. | append(l[k].Participants,DPMUID) /* add UID of new bidder to market to list of current participants |
| | */ |
| 15. | DPMUID.holdings.01=DPMUID.holdings.02=0 |
| 16. | } |
| 17. | O1.price = (e\hat{ }(q1/b)) / (e\hat{ }(q1/b) + e\hat{ }(q2/b)) /* price function to determine the current price of outcome 1 |
| | */ |
| 18. | O2.price = (e\hat{ }(q2/b)) / (e\hat{ }(q1/b) + e\hat{ }(q2/b)) /* price function to determine the current price of outcome 2 |
| | */ |
| 19. | if(message.type==bid) |
| 20. | { |
| 21. | if (event=submitorder) /* let user play around. Commit only when they press submit */ |
| 22. | { |
| 23. | Pos = order.position /* get position of bidder (buy/sell) */ |
| 24. | Oi = order.outcome /* get which outcome bidder j wants to buy or sell */ |
| 25. | ordertype = order.type /*whether bidder wants to specify quantities or probabilities */ |
| 26. | if(ordertype==quantity) |
| 27. | { |
| 28. | q = order.quantity /*quantity bidder j wants to buy or sell */ |
| 29. | if(Oi==O1 && Pos==”buy”) |
| 30. | { |
| 31. | pay[DPMUID] = c(q1+q,q2) − c(q1,q2) /* cost function to determine price to pay */ |
| 32. | if(pay[DPMUID] < max(BudgetLowerBound,DPMUID.budget)) |
| 33. | { |
| 34. | DPMUID.holdings.O1 += q |
| 35. | DPMUID.budget −= pay[DPMUID] |
| 36. | q1 += q |
| 37. | } |
| 38. | else |
| 39. | { |
| 40. | message(DPMUID,“not enough budget. Try again”) |
| 41. | message(DPMUID Current Budget, max(BudgetLowerBound,DPMUID.budget)) |
| 42. | } |
| 43. | } |
| 44. | if(Oi==O1 && Pos==”sell”) |
| 45. | { |
| 46. | if(DPMUID.holdings.O1 >= q) /* no short-selling. Bidders can only sell if they hold securities |
| | */ |
| 47. | { |
| 48. | pay[DPMUID] = c(q1−q,q2) − c(q1,q2) |
| 49. | DPMUID.holdings.O1 −= q |
| 50. | DPMUID.budget −= pay[DPMUID] |
| 51. | q1 −= q |
| 52. | } |
| 53. | else |
| 54. | { |
| 55. | message(DPMUID %s %s, ,“not enough shares of security”, O1) |
| 56. | message(DPMUID Current holdings: %d, DPMUID.holdings.O1) |
| 57. | } |
| 58. | } |
| 59. | if(Oi==O2 && Pos==”buy”) |
| 60. | { |
| 61. | pay[DPMUID] = c(q1,q2+q) − c(q1,q2) /* cost function to determine price to pay */ |
| 62. | if(pay[DPMUID] < max(BudgetLowerBound,DPMUID.budget)) |
| 63. | { |
| 64. | DPMUID.holdings.O2 += q |
| 65. | DPMUID.budget −= pay[DPMUID] |
| 66. | q2 += q |
| 67. | } |
| 68. | else |
| 69. | { |
| 70. | message(DPMUID,“not enough budget. Try again”) |
| 71. | message(DPMUID Current Budget, max(BudgetLowerBound,DPMUID.budget)) |
| 72. | } |
| 73. | } |
| 74. | if(Oi==O2 && Pos==”sell”) |
| 75. | { |
| 76. | if(DPMUID.holdings.O2 >= q) /* no short-selling. Bidders can only sell if they hold securities |
| | */ |
| 77. | { |
| 78. | pay[DPMUID] = c(q1,q2−q) − c(q1,q2) |
| 79. | DPMUID.holdings.O2 −= q |
| 80. | DPMUID.budget −= pay[DPMUID] |
| 81. | q2 −= q |
| 82. | } |
| 83. | else |
| 84. | { |
| 85. | message(DPMUID %s %s, ,“not enough shares of security”, O2) |
| 86. | message(DPMUID Current holdings: %d, DPMUID.holdings.O2) |
| 87. | } |
| 88. | } |
| 89. | |
| 90. | } |
| 91. | --------------------------------------------------Probability------------------------------------------------- |
| 92. | if(ordertype==probability) |
| 93. | { |
| 94. | pricesearch=0.0 |
| 95. | maxPossibleBidGivenCurrentBudget = 0.0 |
| 96. | maxPossiblePayoffsGivenCurrentHoldings = 0.0 |
| 97. | basecost = c(q1,q2) /* optimization */ |
| 98. | q* = 0 |
| 99. | Increment = 1 /* incremental steps used for searching of quantities when prices are specified */ |
| 100. | BidList=[ ] /* list for storing endogenously computed price and corresponding quantity (p,q) series |
| | */ |
| 101. | if(Oi==O1 && buttonPress==”up”) /* equivalent to saying O1 is undervalued and expectedPrice > |
| | O1.price */ |
| 102. | { |
| 103. | /* First compute the max price the user can specify given their current budget. Use to set max of |
| | slider */ |
| 104. | /* to do that first compute ascending price series (as a list). This is an optimization */ |
| 105. | while(maxPossibleBidGivenCurrentBudget < max(BudgetLowerBound,DPMUID.budget)) |
| 106. | { |
| 107. | q* += increment |
| 108. | maxPossibleBidGivenCurrentBudget = c(q1+q*,q2) − basecost /*marginal price of an additional |
| | unit of O1 */ |
| 109. | append([maxPossibleBidGivenCurrentBudget,q*],BidList) |
| 110. | } |
| 111. | max-slider = maxPossibleBidGivenCurrentBudget |
| 112. | } |
| 113. | if(Oi==O1 && buttonPress==”down”) /* equivalent to saying O1 is undervalued and expectedPrice |
| | > O1.price */ |
| 114. | { |
| 115. | while(maxPossibleBidGivenCurrentBudget < max(BudgetLowerBound,DPMUID.budget)) |
| 116. | { |
| 117. | q* += increment |
| 118. | maxPossibleBidGivenCurrentBudget = c(q1+q*,q2) − basecost |
| 119. | append([maxPossibleBidGivenCurrentBudget,q*],BidList) |
| | } |
| 120. | |
| 121. | /* then read in actual orders by user and use above precomputed lists (upBidList and ) to search |
| | and update budgets */ |
| 122. | /* and holdings accordingly */ |
| 123. | expectedPrice = order.probability /*probability of Oi bidder j believes is the chances of outcome i*/ |
| 124. | if(expectedPrice==0 OR expectedPrice==1) message(DPMUID %s,”cannot afford this. Try again”) |
| 125. | if(Oi==O1 && expectedPrice > O1.price) /* if bidder has specified a probability that is > than |
| | current price of O1 */ |
| 126. | { |
| 127. | while(pricesearch!=expectedPrice) /* algorithm below needs to be optimized better */ |
| 128. | { |
| 129. | q* +=increment |
| 130. | pricesearch = c(q1+q*,q2) − basecost |
| 131. | } |
| 132. | if(pricesearch < max(BudgetLowerBound,DPMUID.budget)) |
| 133. | { |
| 134. | DPMUID.holdings.O1 += q* /* bidder becomes buyer of q* quantities of O1 */ |
| 135. | DPMUID.budget −= pricesearch |
| 136. | q1 += q* |
| 137. | } |
| 138. | else |
| 139. | { |
| 140. | message(DPMUID,“not enough budget to support your bid. Try again”) |
| 141. | message(DPMUID Current Budget, max(BudgetLowerBound,DPMUID.budget)) |
| 142. | } |
| 143. | } |
| 144. | if(Oi==O1 && expectedPrice < O1.price) /* if bidder has specified a probability that is < current |
| | price of O1 */ |
| 145. | { |
| 146. | while(pricesearch!=expectedPrice) |
| 147. | { |
| 148. | q* −= increment |
| 149. | pricesearch = c(q1−q*,q2) − basecost |
| 150. | } |
| 151. | if(DPMUID.holdings.O1 >=q*) /* no short-selling. Bidders can only sell if they hold securities */ |
| 152. | { |
| 153. | DPMUID.holdings.O1 −= q* /* bidder becomes buyer of q* quantities of O1 */ |
| 154. | DPMUID.budget −= pricesearch |
| 155. | q1 −= q* |
| 156. | } |
| 157. | else |
| 158. | { |
| 159. | message(DPMUID,%s %s %s, “you do not have enough of”, O1, “to support your bid”) |
| 160. | message(DPMUID Current holdings: %d, DPMUID.holdings.O1)) |
| 161. | } |
| 162. | } |
| 163. | if(Oi==O2 && expectedPrice > O2.price) /* if bidder has specified a probability that is > than |
| | current price of O2 */ |
| 164. | { |
| 165. | while(pricesearch!=expectedPrice) |
| 166. | { |
| 167. | q* +=increment |
| 168. | pricesearch = c(q1,q2+q*) − basecost |
| 169. | } |
| 170. | if(pricesearch < max(BudgetLowerBound,DPMUID.budget)) |
| 171. | { |
| 172. | DPMUID.holdings.O2 += q* /* bidder becomes buyer of q* quantities of O2 */ |
| 173. | DPMUID.budget −= pricesearch |
| 174. | q2 += q* |
| 175. | } |
| 176. | else |
| 177. | { |
| 178. | message(DPMUID,“not enough budget to support your bid. Try again”) |
| 179. | message(DPMUID Current Budget, max(BudgetLowerBound,DPMUID.budget)) |
| 180. | } |
| 181. | } |
| 182. | if(Oi==O2 && expectedPrice < O2.price) /* if bidder has specified a probability that is < current |
| | price of O2 */ |
| 183. | { |
| 184. | while(pricesearch!=expectedPrice) |
| 185. | { |
| 186. | q* −= increment |
| 187. | pricesearch = c(q1,q2−q*) − basecost |
| 188. | } |
| 189. | if(DPMUID.holdings.O2 >= q*) /* no short-selling. Bidders can only sell if they hold securities */ |
| 190. | { |
| 191. | DPMUID.holdings.O2 −= q* /* bidder becomes buyer of q * quantities of O2 */ |
| 192. | DPMUID.budget −= pricesearch |
| 193. | q2 −= q* |
| 194. | } |
| 195. | else |
| 196. | { |
| 197. | message(DPMUID,%s %s %s, “you do not have enough of”, O2, “to support your bid”) |
| 198. | message(DPMUID Current holdings: %d, DPMUID.holdings.O2)) |
| 199. | } |
| 200. | } |
| 201. | } |
| 202. | } |
| 203. | } |
| 204.} | |

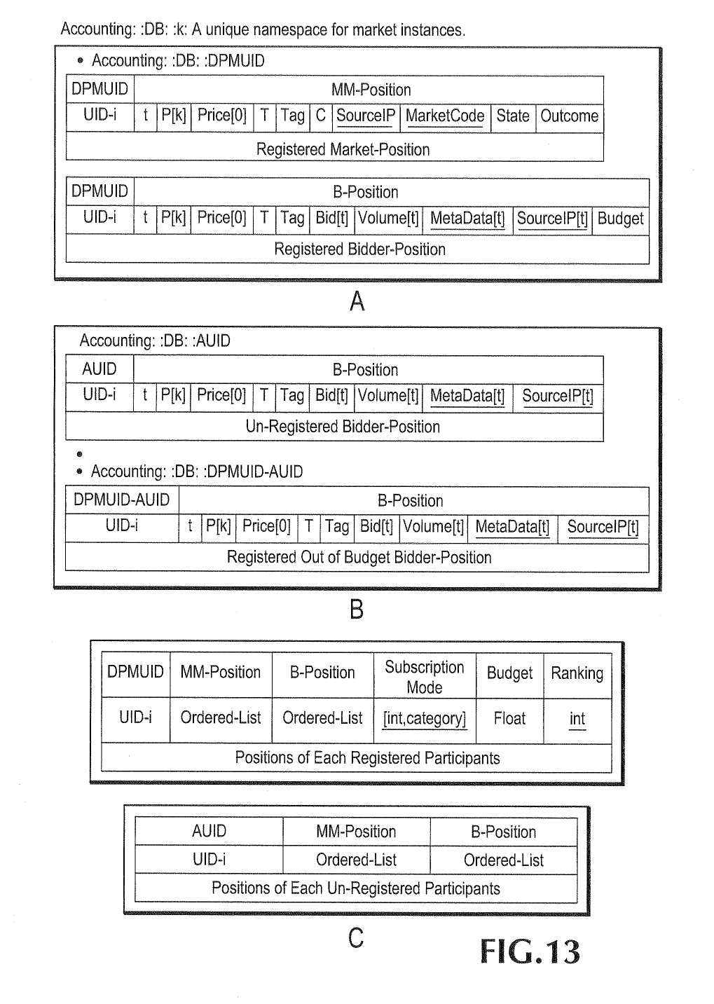

Referring now to FIG. 13, databases to support the foregoing systems and methods may include the following types of structure or records, by way of illustration and not limitation. “Accounting::DB::k:” is a unique namespace for market instances. In FIG. 13, part A, illustrates sample data structures for market makers and bidders who are registered and thus have a DPMUID. Part B in the figure illustrates examples of structures for tracking un-registered bidder positions, and registered out-of-budget bidder positions.

The above DBs can then be used to represent the summary of each position of each participant. The B-position refers to the bidding positions a participant is currently subscribed to. And the subscription mode is how the bidder would like the form (category) and frequency of update information in each market it has subscribed to. Referring again to FIG. 13, part C illustrates structures for positions of registered and un-registered participants. An unregistered participant summary statistics is more degenerate, having only MM or bidder positions.

It will be obvious to those having skill in the art that many changes may be made to the details of the above-described embodiments without departing from the underlying principles of the invention. The scope of the present invention should, therefore, be determined only by the following claims.

1. A computer-implemented system for implementing a distributed prediction market comprising:
a server computer coupled to the internet for communications;
a software widget executable on a remote computer and arranged to enable communications with the server computer via the internet;
DPM web application software code executable on the server computer, the web application including
first logic for registering remote users who wish to register with the system;
second logic for market provisioning, the second logic enabling a remote market-maker, via communication with the web application, to initiate a new market instance, the new market instance comprising a proposition having a true or false outcome, and having a maturity date/time at which the outcome will become fixed; and further enabling the remote market-maker to provide an interface on its web site for a remote user to participate in the new market instance via the market-makers's web site;
the second logic including logic for generating code to enable a remote user to interact with the new market instance through a landing web page or through a widget operable on a remote web site, and means for downloading the generated code to a target landing page or widget, as determined by the remote user who initiated the new market instance;
third logic for market execution, the third logic including an open-loop, event-driven function to receive a proposed bid from a remote bidder on a selected market, and to provide feedback to the bidder on the predicted effect of the proposed bid; and
wherein the platform maintains and holds state on a live running feed of price statistics for each market instance hosted on the platform and the associated participants.

2. A system according to claim 1 wherein the user registration logic includes registration logic and data storage to implement registration of market makers and registration of bidders; and further wherein the registration logic allocates an initial budget, expressed in an artificial currency, and a unique identifier to each registered bidder.

3. A system according to claim 2 wherein the web application software code computes a rate of currency inflation system wide and adjusts the initial budget allocated to each registered user based on the computed rate of currency inflation.

4. A system according to claim 2 wherein the web application further implements a currency exchange facility to enable users to exchange currency in their account to a currency of an external web site or MMORPG—Massively Multiplayer Online Role-Playing Game.

5. A system according to claim 2 wherein the widget is arranged to present information about a selected market instance while the selected market instance is running, the information communicated to the widget by the web application software code.

6. A system according to claim 5 wherein the web application communicates updated information to the widget if a registered user associated with the widget subscribes to receive updates on the selected market instance.

7. A system according to claim 1 wherein the user is presented all open related markets so as to enable the user to select additional market instances for participation.

8. A system according to claim 1 wherein the user is able to subscribe to selected market instances to receive updates.

9. A system according to claim 8 wherein the user is able to select a frequency and criteria for receiving price updates to markets that bidder is subscribed to.

10. A system according to claim 1 wherein the market provisioning logic enables a user who initiates a new market instance to specify participation constraints for the new market instance.

11. A system according to claim 1 wherein the third logic for market execution is arranged to receive bids from remote users via a widget on a remote site or via a DPM landing page.

12. A system according to claim 1 wherein the third logic for market execution is arranged to capture a proposed bid in a selected market; if the proposed bid is expressed as a quantity of shares to purchase in the selected market, computing a corresponding cost for the shares proposed to be purchased, based on a market scoring rule calculation, and then determining whether the proposed bid fits within the remote user's current budget, and if so, accepting the bid, and updating the user's account to reflect the purchase.

13. A system according to claim 1 wherein the third logic for market execution is arranged to capture a proposed bid in a selected market; if the proposed bid is expressed as a price of shares to purchase in the selected market, reflecting a probability that the corresponding market instance proposition will become true, computing a corresponding number of the shares to be purchased, based on a market scoring rule calculation, and then determining whether the proposed bid fits within the remote user's current budget, and if so, accepting the bid, and updating the user's account to reflect the purchase.

14. A system according to claim 1 wherein the third logic for market execution is arranged to:
receive an indication of a proposed bid from a remote user,
determine whether the proposed bid fits within the remote user's current budget, and
if the proposed bid does not fit within the remote user's current budget, so informing the remote user, and executing predetermined out-of-budget actions.

15. A system according to claim 14 wherein the market execution logic out-of-budget actions include at least one of offering a loan to the user or adjusting the proposed bid to a level within the current budge.

16. A computer program product [widget] for implementation of distributed prediction markets comprising:
first code for communicating with a central DPM platform to enable a user of the widget to observe and interact with selected prediction markets hosted by the DPM platform;
second code for displaying a description of a selected open one of the hosted prediction markets, including a current price or probability of the underlying proposition becoming true by the maturity date;
third code for receiving a proposed bid input by a user, the third code providing an interactive display showing the expected results of a proposed bid, and posting the proposed bid to the DPM platform in response to a user input to submit the bid; and
fourth code for reporting the results of the selected market after the market closes.

17. A software widget according to claim 16 wherein the third code displays expected results of the proposed bid on the user's budget in the case of a registered user.

18. A software widget according to claim 16 and further including code for displaying related markets, and enabling the user to participate in at least one of the related markets.

19. A software widget according to claim 16 and further wherein the code enabling participation permits bids to be entered by non-registered user, and the central DPM platform stores the bids entered by non-registered users without affecting the corresponding prediction market.

20. A software widget according to claim 16 and further wherein the widget receives probability-time sequence data for the selected market from the central platform and graphically displays the probability-time sequence data.

21. A software widget according to claim 20 and further wherein the widget receives updates for the selected market from the central platform and displays the updates.

22. A software widget according to claim 21 and further wherein the updates include indications of additional users who are participating in the selected market and or new bids received in the selected market.

23. A software widget according to claim 16 and further wherein the widget provides an interface for a user to search for markets among the open markets hosted on the central platform.

24. A software widget according to claim 16 and further wherein the widget displays a graphical object that presents the current price, a maximum probability based on the current remaining budget for the identified user, and a region intermediate the current price and maximum probability indications, so as to enable the user to graphically select a value along the intermediate range as a proposed bid.

25. A computer program product for implementing and distributing prediction markets across the internet, the computer program product comprising a computer-readable storage medium containing computer program code for performing a method comprising:
receiving input from a remote web site requesting a new market instance;
receiving from the remote web site a definition of the requested new market instance, including a corresponding proposition and maturity date/time;
creating and provisioning the new market instance;
said provisioning including generating code for participation in the new market instance by a user of the remote web site;
downloading the generated code to the web site for deployment so as to enable visitors to the web site to participate in the market instance; and
commencing and running the market instance until the maturity date/date or earlier abandonment.

26. The computer program product of claim 25, wherein running the market instance includes:
receiving bids from visitors to the remote web site, wherein a bid is expressed in terms of a probability of a given outcome of the corresponding proposition and, or quantities of shares needed;
registering the bidder if the bidder is not a registered bidder;
if the bidder registers, allocating an initial budget, expressed in an artificial currency, and a unique identifier to the registered bidder;
converting the bid received from the registered user into a volume of shares or prices at a current price of a security corresponding to the selected outcome of the corresponding proposition;
determining whether or not the registered bidder has sufficient currency in her account to make the purchase corresponding to the bid; and
if the registered bidder has sufficient currency in her account to make the purchase, effecting the purchase, and updating price-time statistics of the market instance.

27. The computer program product of claim 26, wherein the method further comprises pushing updates out to registered users who are associated with the market instance in response to the effected purchase.

28. The computer program product of claim 27, wherein the method further comprises pushing updates out to widgets associated with the market instance.

29. The computer program product of claim 26, wherein the method further comprises if the registered bidder does not have sufficient currency in her account to make the purchase, offering a loan of additional currency to the registered user sufficient in amount to make the purchase.

30. The computer program product of claim 26, wherein the method further comprises if the registered bidder does not have sufficient currency in her account to make the purchase, offering to adjust the bid to a level within the bidders current budget.
